(19) United States
(12) Patent Application Publication
(10) Pub. No.: US 2015/0338917 A1
(43) Pub. Date: Nov. 26, 2015

(54) DEVICE, SYSTEM, AND METHOD OF CONTROLLING ELECTRONIC DEVICES VIA THOUGHT

(71) Applicant: SIA TECHNOLOGY LTD., Herzelia (IL)

(72) Inventors: Ami Steiner, Tel Aviv (IL); Roee Nahir, Tel-Aviv (IL); Barak Ben Eliezer, Modiin (IL)

(21) Appl. No.: 14/654,549

(22) PCT Filed: Dec. 24, 2013
(86) PCT No.: PCT/IB2013/061313

§ 371 Date: Jun. 22, 2015

Related U.S. Application Data
(60) Provisional application No. 61/745,817, filed on Dec. 26, 2012.

(51) Int. Cl. G06F 3/01

(52) U.S. Cl. CPC G06F 3/015

(57) ABSTRACT

A method of controlling an electronic device thought, includes: capturing through one or more electrodes, located in proximity to a brain of a user, signals of brainwave activity of said user; analyzing said signals to detect a pattern of brainwave activity of said user; based on the detected pattern, determining that the user thinks about a command that controls an electronic device; and based on said determining, triggering the electronic device to perform said command.

### FIELD OF THE INVENTION

The present invention relates to the field of electronic devices.

### BACKGROUND

Millions of users worldwide utilize electronic devices, for example, a personal computer, a laptop computer, a tablet, a smartphone, a portable audio/video player, or the like. Such devices may be used for performing various tasks, for example, browsing the Internet, accessing social media websites, playing games, sending and receiving electronic mail (email) messages, watching video clips, listening to audio clips, reading electronic books, or the like.

Most electronic devices include an input unit to receive user input or to allow the user to interact with the device; such input units may include, for example, a keyboard, a mouse, a touch-pad, or the like.

Some electronic devices may include a touch-screen, allowing a user to provide input by touching the screen, by dragging a finger on the screen, by tapping on an on-screen keyboard, or by otherwise providing tactile input via such touch-screen. A touch-screen is particularly common in tablets and smartphones.

### SUMMARY

The present invention may include, for example, devices, systems, methods, computerized programs and computerized applications which may allow a user to control or command an electronic device via thought.

In accordance with the present invention, for example, a method may comprise: capturing through one or more electrodes, located in proximity to a brain of a user, signals of brainwave activity of said user; analyzing said signals to detect a pattern of brainwave activity of said user; based on the detected pattern, determining that the user thinks about a command that controls an electronic device; based on said determining, triggering the electronic device to perform said command.

In some implementations, the analyzing comprises: comparing a current pattern of brainwave activity of said user, to one or more patterns previously-recorded in a training session.

In some implementations, the analyzing comprises: based on user behavior subsequent to performance of said command, generating positive feedback indicating that the determination that the user was thinking about said command was correct.

In some implementations, the analyzing comprises: based on user behavior subsequent to performance of said command, generating negative feedback indicating that the determination that the user was thinking about said command was incorrect.

In some implementations, the analyzing comprises: locally analyzing said signals at a wearable a headset comprising said one or more electrodes and further comprising a processor able to locally perform said analyzing.

In some implementations, the analyzing comprises: wirelessly transmitting said signals to a processor detached from said electrodes; and analyzing said signals at said processor.

In some implementations, the analyzing comprises: wirelessly transmitting said signals to said electronic device which is detached from said electrodes; analyzing said signals at said electronic device by a processor comprised in said electronic device.

In some implementations, the electronic device comprises a device selected from the group consisting of: a smartphone, a tablet, an audio player, a video player, a personal computer, a laptop computer, a gaming device, an electronic book reader.

In some implementations, analyzing said signals comprises: down-sampling said signals from a first sampling rate at which said signals are captured, to a second, reduced, sampling rate; analyzing the down-sampled signals.

In some implementations, analyzing said signals comprises: determining a context of said electronic device; taking into account said context within said analyzing of said signals.

In some implementations, analyzing said signals comprises: determining a context of said electronic device; determining that said pattern of brainwave activity corresponds to two or more possible interpretations corresponding to two or more commands, respectively; selecting to execute one of said two or more commands by taking into account said context of the electronic device.

In some implementations, the method comprises: in a think-to-unlock module, determining that said pattern of brainwave activity corresponds to a user thought of a command to unlock an electronic device; and triggering said electronic device to unlock.

In some implementations, the method comprises: in a brainwave-based biometric module, extracting a pattern of brainwave activity of said user for subsequent utilization as a biometric property of said user.

In some implementations, the method comprises: extracting a pattern of brainwave activity of said user for subsequent utilization as a user-specific treat for user authentication.

In some implementations, the method comprises: in a brainwave-based challenge/response module: presenting to the user a challenge; capturing brainwave activity of said user in response to said challenge; authenticating said user to a service, based on a match between (a) said brainwave activity in response to said challenge, and (b) previously-captured brainwave activity of said user.

In some implementations, the method comprises: determining whether an estimated thought of a user, which is estimated based on said pattern of brainwave activity, is a user-triggered thought or an event-triggered thought; determining that said pattern of brainwave activity corresponds to two or more possible interpretations corresponding to two or more commands, respectively; selecting to execute one of said two or more commands by taking into account said determination of whether the estimated thought of the user is a user-triggered thought or an event-triggered thought.

In some implementations, the method comprises: capturing multimedia data associated with activities of said user, the multimedia data comprises at least one of: video data, audio data; based on analysis of said signals indicating brainwave activity, determining that a portion of said multimedia data corresponds to a time-period in which said user had a particular state-of-mind; tagging said portion of the multimedia data with a tag indicating said particular state-of-mind.

In some implementations, said state-of-mind comprises one or more of: happiness, sadness, excitement, boredom, being interested, being attentive, being distracted.

In some implementations, the method comprises: receiving a user-provided state-of-mind tag; automatically compiling a summary clip that comprises one or more portions of said multimedia data that correspond to said user-provided state-of-mind tag.

In some implementations, the method comprises: overriding said tagging based on an utterance of the user indicating that said portion of the multimedia data is not to be tagged with said state-of-mind tag.

In some implementations, the method comprises: overriding said tagging based on a thought of said user, estimated from sensed brainwave activity of said user, indicating that said portion of the multimedia data is not to be tagged with said state-of-mind tag.

In some implementations, the method comprises: capturing multimedia data associated with activities of said user, the multimedia data comprises at least one of: video data, audio data; based on analysis of said signals indicating brainwave activity of said user, identifying portions of said multimedia data which correspond to time-periods in which said user was happy; automatically compiling a happiness-oriented summary clip that comprises said portions of said multimedia data.

In some implementations, the method comprises: capturing multimedia data associated with activities of said user, the multimedia data comprises at least one of: video data, audio data; based on analysis of said signals indicating brainwave activity of said user, identifying portions of said multimedia data which correspond to time-periods in which said user was excited; automatically compiling an excitement-oriented summary clip that comprises said portions of said multimedia data.

In some implementations, the method comprises: capturing multimedia data associated with a lecture that the user attends, the multimedia data comprises at least one of: video data, audio data; based on analysis of said signals indicating brainwave activity of said user, identifying portions of said multimedia data which correspond to time-periods in which said user was focused; automatically compiling a focus-oriented summary clip that comprises said portions of said multimedia data.

In some implementations, the method comprises: capturing multimedia data associated with a text that the user reads, the multimedia data comprises at least one of: video data, audio data; based on analysis of said signals indicating brainwave activity of said user, identifying portions of said multimedia data which correspond to time-periods in which said user was focused; automatically compiling a focus-oriented summary clip that comprises said portions of said multimedia data.

In some implementations, the method comprises: capturing multimedia data associated with a lecture that the user attends, the multimedia data comprises at least one of: video data, audio data; based on analysis of said signals indicating brainwave activity of said user, identifying portions of said multimedia data which correspond to time-periods in which said user was unfocused; automatically compiling a review-oriented summary clip that comprises said portions of said multimedia data.

In some implementations, the method comprises: capturing multimedia data associated with a text that the user reads, the multimedia data comprises at least one of: video data, audio data; based on analysis of said signals indicating brainwave activity of said user, identifying portions of said multimedia data which correspond to time-periods in which said user was unfocused; automatically compiling a review-oriented summary clip that comprises said portions of said multimedia data.

In some implementations, the method comprises: capturing multimedia data associated with a lecture that the user attends, the multimedia data comprises at least one of: video data, audio data; based on analysis of said signals indicating brainwave activity of said user, identifying portions of said multimedia data which correspond to time-periods in which said user was interested in the lecture; automatically compiling a user-specific interest-oriented summary clip that comprises said portions of said multimedia data.

In some implementations, the method comprises: capturing multimedia data associated with a text that the user reads, the multimedia data comprises at least one of: video data, audio data; based on analysis of said signals indicating brainwave activity of said user, identifying portions of said multimedia data which correspond to time-periods in which said user was interested in the text being read; automatically compiling a user-specific interest-oriented summary clip that comprises said portions of said multimedia data.

In some implementations, the method comprises: (a) providing to the user a first batch of one or more words in a first language in which the user is proficient; (b) identifying a first brainwave activity of said user in response to said first batch; (c) providing to the user a second batch of one or more words in a second language in which the user is non-proficient; (d) identifying a second brainwave activity of said user in response to said second batch.

In some implementations, the method comprises: based on a comparison of the second brainwave activity to the first brainwave activity, determining whether or not the user comprehends the second batch of one or more words in said second language.

In some implementations, the method comprises: based on a comparison of the second brainwave activity to the first brainwave activity, determining to repeat at least one more iteration of steps (a), (b), (c) and (d).

In some implementations, the method comprises: capturing audio uttered to said user; based on analysis of said signals indicating brainwave activity of said user, identifying a particular batch of one or more words in said audio which the user does not understand; automatically providing to said user a translation of said particular batch, from a source language to a user-preferred language.

In some implementations, providing the translation comprises at least one of: (a) providing to the user an audio utterance of the translation in the user-preferred language; (b) displaying said translation on an optical head mounted display of said user.

In some implementations, the method comprises: capturing audio uttered to said user; based on analysis of said signals indicating brainwave activity of said user, identifying a particular batch of one or more words in said audio which the user does not understand; automatically providing to said user an explanation of said particular batch; wherein the explanation is provided to said user by at least one of: (a) an audio utterance of the explanation in the user-preferred language; (b) displaying said explanation on an optical head mounted display of said user.

In some implementations, the method comprises: capturing a brainwave activity preceding immediately before said user performs a particular action; allowing the user to complete said particular action without intervention; and subsequently, identifying subsequent brainwave activity of said user, and determining that the user is thinking about performing again said particular action.

In some implementations, the method comprises: providing to said user a message notifying the user that he is thinking about performing again said particular action and advising the user to avoid performing said particular action.

In some implementations, the method comprises: providing to said user a message notifying the user that he is thinking about performing again said particular action, and providing to said user information that assists the user in performing again said particular action.

In some implementations, the method comprises: identifying an irregular brainwave activity of said user; based on said identification, and based on a secondary indicator, initiating a medical alert regarding said user; wherein the secondary indicator comprises at least one of: excessive sweating of said user; increased heartbeat rate of said user; irregular body temperature of said user.

In some implementations, the method comprises: correlating between said brainwave activity, and at least one of: (a) a location at which the user is located, (b) a time-of-day, (c) an activity performed by said user; taking into account said correlation within said analyzing of said signals.

In some implementations, wherein triggering the electronic device to perform said command comprises: prior to said triggering, performing a validation process in which said user is requested to confirm that the command determined by said determining step is indeed a command that the user thought; receiving user feedback comprising a user validation of said command; only upon user validation, triggering the electronic device to perform said command.

In some implementations, the method comprises: wherein receiving the user feedback comprises: capturing additional signals of brainwave activity which indicate that the user validates said command.

In some implementations, wherein receiving the user feedback comprises: capturing additional signals of brainwave activity which indicate that the user re-thinks said command.

In some implementations, the method comprises: determining that the user thinks that the user is in a distress situation; and in response to such determination, wirelessly transmitting a distress signal to one or more pre-defined remote recipients.

In some implementations, the method comprises: based on the brainwave activity of the user, determining that the user is thinking about a particular person; determining that the particular person appears in a contact list stored on said electronic device; initiating, through said electronic device of said user, a new communication session between said user and said particular person.

In some implementations, the method comprises: based on the brainwave activity of the user, determining that the user is thinking about a particular code-word which represents a command to terminate an ongoing phone call; in response, terminating a currently-ongoing phone call on said electronic device.

In some implementations, the method comprises: based on the brainwave activity of the user, determining that the user is thinking about a particular pre-defined passphrase, that was previously associated with a batch of one or more operations that said electronic device is capable of performing; in response, triggering said electronic device to perform said batch of one or more operations.

In some implementations, the method comprises: when a telephone call is incoming to the electronic device, analyzing the brainwave activity of the user to determine if the user is thinking to accept the incoming telephone call or to reject the incoming telephone call; based on said analyzing, performing acceptance or rejection of the incoming telephone call in accordance with the determined user thought.

In some implementations, the method comprises: based on the brainwave activity of the user, determining that the user is thinking a command to increase a volume level of audio produced by said electronic device; in response, triggering said electronic device to increase the volume level of said audio produced by said electronic device.

In some implementations, the method comprises: based on the brainwave activity of the user, determining that the user is thinking a command to decrease a volume level of audio produced by said electronic device; in response, triggering said electronic device to increase the volume level of said audio produced by said electronic device.

In some implementations, the method comprises: based on the brainwave activity of the user, determining that the user is thinking a command to modify a brightness level of a screen of said electronic device; in response, triggering said electronic device to modify the brightness level of the screen of said electronic device.

In some implementations, the method comprises: based on the brainwave activity of the user, determining that the user is thinking a command to toggle an airplane mode of said electronic device, wherein the airplane mode comprises a mode in which all wireless transceivers of said electronic device are disabled; in response, triggering said electronic device to toggle said airplane mode.

In some implementations, the method comprises: based on the brainwave activity of the user, determining that the user is thinking a command to toggle a value of a binary operational parameter of said electronic device; in response, triggering said electronic device to toggle the value of said binary operational parameter of the electronic device.

In some implementations, the method comprises: based on the brainwave activity of the user, determining that the user is thinking of a command to scroll a list of selectable items displayed on said electronic device; in response, triggering said electronic device to scroll said list.

In some implementations, the method comprises: based on the brainwave activity of the user, determining that the user is thinking of a command to select an item from said list of selectable items displayed on said electronic device; in response, triggering said electronic device to select said item from said list.

In some implementations, the method comprises: turning-on a dictation-by-thought mode of said electronic device; based on the brainwave activity of the user, determining that the user is thinking of a particular phrase of text comprising one or more words of a natural language; adding said phrase to a text being composed on said electronic device.

In some implementations, the method comprises: based on the brainwave activity of the user, determining that the user is thinking a command to toggle activation/deactivation of a camera of said electronic device; in response, triggering said electronic device to toggle activation/deactivation of said camera of the electronic device.

In some implementations, the method comprises: based on the brainwave activity of the user, determining that the user is thinking a command to advance an email program from a presently-displayed email message to a next email message; in response, triggering said electronic device to advance the email program from the presently-displayed email message to the next email message.

In some implementations, the method comprises: based on the brainwave activity of the user, determining that the user is thinking a command to launch a particular application that is installed on the electronic device; in response, triggering said electronic device to launch said particular application that is installed on the electronic device.

In some implementations, the method comprises: based on the brainwave activity of the user, determining that the user is thinking a command to close a currently-displayed application which is currently displayed on a screen of the electronic device; in response, triggering said electronic device to close said currently-displayed application.

In some implementations, the method comprises: based on the brainwave activity of the user, determining that the user is thinking a command to activate a command in a currently-running application which is currently displayed on a screen of the electronic device; in response, triggering said electronic device to activate said command in said currently-running application which is currently displayed on the screen of the electronic device.

In some implementations, the method comprises: based on the brainwave activity of the user, determining that the user is thinking a command to edit a meeting in a calendar application installed on the electronic device; in response, triggering said electronic device to edit the meeting in the calendar application installed on the electronic device.

In some implementations, the method comprises: based on the brainwave activity of the user, determining that the user is thinking a command to edit an alarm clock event in a clock application installed on the electronic device; in response, triggering said electronic device to edit the alarm clock event in the clock application installed on the electronic device.

In some implementations, the method comprises: based on the brainwave activity of the user, determining that the user is thinking a request to locate the electronic device; in response, triggering said electronic device to convey its location to said user by generating an audible signal.

In some implementations, the method comprises: based on the brainwave activity of the user, determining that the user is thinking a request to locate the electronic device; in response, triggering said electronic device to convey its location to said user by wirelessly sending, to one or more pre-defined recipients, a message indicating a GPS location of said electronic device.

In some implementations, the method comprises: performing a training session in which the user thinks of an image that corresponds to a password for a particular service; recording brainwave activity of the user during said training session; subsequently, based on brainwave activity analysis, authorizing an access to said particular service only if brainwave activity analysis indicates that the user thinks of said image.

In some implementations, the method comprises: based on the brainwave activity of the user, determining that the user is thinking of a command to perform a touch-screen gesture on a touch-screen of the electronic device, wherein the touch-screen gesture comprises a gesture selected from the group consisting of: zoom-in, zoom-out, scroll down, scroll up, swipe right, swipe left, swipe down, swipe left; in response, triggering said electronic device to operate as if said touch-screen gesture was performed on the touch-screen of the electronic device.

In some implementations, the method comprises: based on analysis of brainwave activity of the user, determining that the user switched from being non-alert to being alert; in response, triggering said electronic device to switch from locked mode to unlocked mode.

In some implementations, the method comprises: based on analysis of brainwave activity of the user, determining that the user switched from being alert to being drowsy; in response, triggering said electronic device to gradually fade-out audio being played on the electronic device.

In some implementations, the method comprises: based on analysis of brainwave activity of the user, determining that the user switched from being alert to being drowsy; in response, triggering said electronic device to pause an application currently running on the electronic device.

In some implementations, the method comprises: performing a machine-training session in which the user repeatedly thinks of a particular command; capturing brainwave signals during said training session; storing the captured brainwave signals as reference signals for subsequent analysis of subsequent brainwave signals.

In some implementations, the method comprises: based on analysis of brainwave activity of the user, determining a single thought of the user; based on said single thought, triggering said electronic device to automatically perform a batch of two or more pre-defined operations.

In some implementations, the method comprises: based on analysis of brainwave activity of the user, determining that the user is thinking of being late to a pre-scheduled meeting; extracting from a calendar application that is utilized by said user, contact details of at least one attendee of said pre-scheduled meeting; wirelessly sending to said at least one attendee of said pre-scheduled meeting a notification from said user, indicating that said user will arrive late to said pre-scheduled meeting.

In some implementations, the method comprises: based on analysis of brainwave activity of the user, and while the user is composing a text message on said electronic device, determining that the user is feeling a particular emotion; automatically adding, to said text message that the user is composing on said electronic device, an emoticon representing said particular emotion.

In some implementations, the method comprises: based on analysis of brainwave activity of a recipient of said text message, determining that said recipient is feeling another emotion; notifying to said recipient, that the emotion that said recipient is feeling differs from the emotion that said user was feeling when said user was composing said text message.

In some implementations, the method comprises: based on analysis of brainwave activity of the user, and while the user is listening to a particular song of a playlist via a music player application of said electronic device, determining that the user is thinking a command to advance said music player application to a different song from said playlist; based on said determining, triggering said music player application of said electronic device to play said other song of said playlist.

In some implementations, the method comprises: based on analysis of brainwave activity of the user, determining that the user is thinking about a particular song; based on said determining, automatically obtaining a digital format of said song from an online music store.

In some implementations, the method comprises: based on analysis of brainwave activity of the user, determining that the user is thinking about purchasing a particular item; based on said determining, automatically placing a purchase order for said particular item, on behalf of said user, at an online store.

In some implementations, the method comprises: based on analysis of brainwave activity of the user, determining that the user is feeling a particular emotion; based on said determining, automatically selecting to playback to said user, on said electronic device, music that corresponds to said particular emotion.

In some implementations, the method comprises: based on analysis of brainwave activity of the user, determining one or more properties of a state-of-mind of said user; based on said determining, generating advertisement content tailored to suit said particular state-of-mind of said user.

In some implementations, the method comprises: based on analysis of brainwave activity of the user, determining one or more properties of a state-of-mind of said user; based on said determining, serving to said user Internet content tailored to suit said particular state-of-mind of said user.

In some implementations, the method comprises: based on the brainwave activity of the user, determining that the user is thinking a command to toggle activation/deactivation of an electronic appliance other than said electronic device; in response, wirelessly triggering said electronic appliance to toggle activation/deactivation of said electronic appliance.

In some implementations, the method comprises: based on the brainwave activity of the user, determining that the user is thinking a command to toggle activation/deactivation of a vehicular component other than said electronic device; in response, wirelessly triggering said vehicular component to toggle activation/deactivation of said vehicular component.

In some implementations, the method comprises: based on analysis of brainwave activity of the user, and while the user is watching a particular channel on a television, determining that the user is thinking a command to switch the television to a different channel; based on said determining, automatically and wirelessly switching said television to said different channel.

In some implementations, the method comprises: based on analysis of brainwave activity of the user, and while the user is listening to a particular channel on a radio, determining that the user is thinking a command to switch the radio to a different channel; based on said determining, automatically and wirelessly switching said radio to said different channel.

In some implementations, the method comprises: based on analysis of brainwave activity of the user, and while the user is seated in a non-moving vehicle, determining that the user is thinking a command to start an ignition of said vehicle; based on said determining, automatically starting the ignition of said car.

In some implementations, the method comprises: automatically starting the ignition of said car is performed (a) without turning a car key, and (b) without pressing a vehicular button.

In some implementations, the method comprises: based on the brainwave activity of the user, determining that the user is thinking a command to control an electronic appliance other than said electronic device; in response, wirelessly controlling said electronic appliance in accordance with said command that said user is thinking.

In some implementations, the method comprises: based on the brainwave activity of the user, determining that the user is thinking a command to control an illumination level of a dimmer light; in response, wirelessly triggering said dimmer light to modify said illumination level in accordance with said command that said user is thinking.

In some implementations, the method comprises: based on the brainwave activity of the user, and while the user is reading an electronic book on said electronic device, determining that the user is thinking a command to turn a page of said electronic book; in response, triggering said electronic device to turn the page in said electronic book that the user is reading.

In some implementations, the method comprises: based on the brainwave activity of the user, and while the user is watching a television program that includes audience voting, determining that the user is thinking a command to cast a vote in favor of a particular option out of multiple options; in response to said determining, automatically casting said vote, on behalf of said user, in favor of said particular option.

In some implementations, automatically casting said vote comprises an operation selected from the group consisting of: automatically casting said vote by automatically sending an SMS message; automatically casting said vote by automatically placing a telephone call; automatically casting said vote by automatically via an Internet-based voting interface.

In some implementations, the method comprises: presenting to the user, via said electronic device, a yes-or-no question; based on the brainwave activity of the user, determining whether the user is thinking “yes” or “no”; in response to said determining, providing to at least one application of said electronic device a signal indicating whether the user is thinking “yes” or “no”.

In some implementations, the method comprises: based on the brainwave activity of the user, determining that the user is thinking a particular question that includes one or more keywords; in response to said determining, and based on said one or more keywords, automatically obtaining from the Internet an answer to said particular question; and presenting said answer to said user via said electronic device.

In some implementations, the method comprises: based on the brainwave activity of the user, determining that the user is thinking a question which queries what the current time is; in response to said determining, notifying the current time to said user.

In some implementations, the method comprises: based on the brainwave activity of the user, determining that the user is thinking a question which queries what the current calendar date is; in response to said determining, notifying the current calendar date to said user.

In some implementations, the method comprises: based on the brainwave activity of the user, determining that the user is thinking about a particular person; in response to said determining, automatically querying whether or not said particular person is available to communicate with said user.

In some implementations, the method comprises: based on the brainwave activity of the user, determining that the user is thinking a question which queries who is a person that said user is communicating with; in response to said determining, automatically obtaining identifying information about said person, and notifying said identifying information to said user.

In some implementations, the method comprises: based on brainwave activity of a non-human animal, determining a state-of-mind of said non-human animal; in response to said determining, notifying to said user the determined state-of-mind of said non-human animal. In some implementations, determining the state-of-mind of said non-human animal comprises at least one of: based on brainwave activity of said non-human animal, determining that said non-human animal is happy; based on brainwave activity of said non-human animal, determining that said non-human animal is sad; based on brainwave activity of said non-human animal, determining that said non-human animal is angry; based on brainwave activity of said non-human animal, determining that said non-human animal is anxious.

In some implementations, the method comprises: based on analysis of brainwave activity of the user, and while the user is composing a text message on said electronic device, determining that the user is thinking a particular phrase that the user did not yet fully type; based on said determining, automatically completing to type said particular phrase on said electronic device.

In some implementations, the method comprises: based on analysis of brainwave activity of the user, and while the user is browsing an Internet web-page having a social media button, determining that the user likes said Internet web-page; based on said determining, automatically engaging said social media button to signal that the user likes said Internet web-page.

In some implementations, the method comprises: based on analysis of brainwave activity of the user, and while the user is browsing an Internet web-page having a social media button, determining that the user would like to follow said Internet web-page; based on said determining, automatically engaging said social media button to signal that the user would like to follow said Internet web-page.

In some implementations, the method comprises: based on analysis of brainwave activity of the user, and while the user is reviewing educational content, determining whether the user feels confusion or understanding of the educational content; based on said determining, automatically signaling to a server of said educational content whether the user feels confusion or understanding of the educational content.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block-diagram illustration of a system, in accordance with some demonstrative embodiments of the present invention;

FIG. 2 is a schematic illustration demonstrating interactions among system components, in accordance with some demonstrative embodiments of the present invention;

FIG. 3 is a schematic block-diagram illustration of a system, in which a headset and a smartphone communicate directly, in accordance with some demonstrative embodiments of the present invention; and

FIGS. 4A-4F are schematic block-diagram illustrations of batches of brainwave-based modules and other related modules, in accordance with some demonstrative embodiments of the present invention.

### DETAILED DESCRIPTION OF THE PRESENT INVENTION

In the following detailed description, numerous specific details are set forth in order to provide a thorough understanding of some embodiments. However, it may be understood by persons of ordinary skill in the art that some embodiments may be practiced without these specific details. In other instances, well-known methods, procedures, components, units and/or circuits have not been described in detail so as not to obscure the discussion.

The present invention may comprise devices, systems, and methods of controlling electronic devices via thought, or via analysis or detection of brainwaves or brainwave patterns that correspond to pre-defined or pre-taught patterns.

The present invention allows a user to control an electronic device via thought. A user may “think” in his brain or mind a particular thought; the thought may be read by one or more portable or wearable electrodes or sensors, which may capture brain waves or other brain activity which corresponds to the thought, and may compare the captured signals with pre-defined signals (e.g., pre-recorded in a training session by that user), in order to translate the sensed thought into a particular action commanded by the user. The commanded action may be performed by the electronic device, immediately and automatically, or after an optional confirmation stage in which the user is asked to act (or to think or re-think) in order to confirm.

The electronic device may be, for example, a smartphone, a cellular phone, a tablet (e.g., Apple iPad, Google Nexus 10), a mini-tablet, (e.g., Apple iPad Mini), a “phablet” or hybrid smartphone-tablet device, a Google Glass device or a similar device, an Augmented Reality (AR) device, a laptop computer, a notebook computer, a tablet computer, a desktop computer, a music player, a video player, a multimedia player, an audio/video player, a stationary or portable device, a wearable device, a wearable computing device, a device having a Head-Mounted Display (HMD) or an Optical HMD (OHMD), a ubiquitous computing device (“ubicomp”), a gaming device, a gaming console, a television set, a set-top box or cable box, a Digital Video Recorder (DVR), a DVD player, a household appliance (e.g., fridge, oven, microwave oven, laundry machine, washer, dryer), a smart-house component (e.g., a light on-off switch, a garage door, window blinds), an augmented reality device, a portable or wearable electronic device or camera (e.g., Google Glass), an electronic reader or e-reader (e.g., Amazon Kindle), an electronic device installed in a vehicle or in a vehicular dashboard (e.g., an on-board or off-board navigation device or mapping device or GPS-based device or other vehicular device), or the like.

The thought which may be sensed and then recognized by the system may be, for example, a thought corresponding to a command (e.g., the command “play” or the command “pause” when the electric device is a portable music player); a command with a subject (e.g., the command “unlock my phone” or “lock my phone” or “answer the incoming call” or “ignore the incoming call” when the electric device is a smartphone; or the command “play next song” when the device is a portable music player); a two-step command or a multiple-step command, optionally including one or more parameters or subjects (e.g., “unlock my phone and open my email application”, or “stop the current song and lock my phone”); a thought corresponding to a natural-language word or term or phrase or response (e.g., the thought “yes” when the smartphone displays the question “do you wish to take this incoming call?”, or the thought “no” when the smartphone displays the question “are you sure you want to delete this image?”); and/or other types of commands, parameters, responses, phrases, words, or the like.

For demonstrative purposes, some embodiments are described herein in the context of using human thoughts in order to “unlock” a smartphone. Other suitable commands may be used, for other suitable purposes, with other suitable electronic devices.

The present invention allows a user to control an electronic device (a smart phone, a tablet, a Google Glass device, an augmented reality device, or the like) by “thinking” in the user's head or by becoming alerted (or any other mental state which may be measured by brain activity). For example, the user may think in his head “unlock” or “unlock my phone”, and the present invention may capture, record, monitor and/or recognize brain-waves or other brain activity which corresponds to that user thought, and may cause the relevant device (e.g., smartphone) to perform the thought-about command (e.g., unlock the smartphone).

In some embodiments, a headset with multiple sensors or electrodes may capture or receive signals corresponding to brain activity of the user; may interpret them based on a lookup table, based on a decoding algorithm, based on a pre-defined database of “thought patterns” that were pre-recorded in a training session, based on machine learning algorithms, based on statistical tests or may otherwise interpret the captured brain activity. The headset may then cause transmission of one or more wireless signals (e.g., a wireless Bluetooth signal) to a nearby device (e.g., smartphone, wearable computer, head mounted display etc), either directly or via an intermediary device (e.g., a laptop or a desktop computer or smart phone), commanding the target device (e.g., smart phone or tablet) to perform the relevant thought-about action or any other action that is logically derived from the users brain activity (e.g., if the user became alerted the device might unlock, if the user is becoming sleepy, it might fade out the music from an mp3 player). In some embodiments the interpretation might be done by device different than the one who recorded the signals. In such embodiment the recorded data might be transmitted (e.g., by a wireless communication signals) to an external processing module which may interoperate the signals and may decide on appropriate action to be done by the commanded device.

Optionally, the invention may recognize, interpret and/or execute complex commands that the user may think in his mind, such as, a command that may include a variable; for example, the invention may correctly distinguish between a user thought of “open the Texting application” and a user thought of “open the Angry Birds game”; or, the present invention may correctly distinguish between a user thought of “respond with Yes to this incoming text message” and a user thought of “respond with No to this incoming text message”; or, the invention may correctly distinguish between a user thought of “skip forward to the next audio song” and a user thought of “skip back to the beginning of the currently-playing audio song”.

The present invention may translate user brain readings into meaningful commands and/or parameters. The present invention may optionally use bi-directional communications to achieve this efficiently. For example, a phone call is received by a smartphone that is configured according to the invention; the smartphone may use bi-directional communication to inform the context manager of the invention that a phone call is being received. This information may be used by the invention's algorithms to provide better classification of the user thoughts and commands for the given situation; for example, the algorithm may use a working assumption that, in this particular context and/or at this particular time and/or event, commands for “hang up” or “answer” or “do nothing” are more likely to be given (thought) by the user, rather than “set-up my alarm clock”.

Data and readings collected from the headset may be analyzed by algorithms and translated into meaningful information, such as thoughts or commands or parameters that the user thinks about. The data may be analyzed in real-time, and/or may be stored in memory for later analysis. The invention may use machine learning algorithms, and thus may keep track of data from different readings, as such data may be used for ongoing training of the algorithm. Accordingly, the invention may utilize a long term storage unit as well as a short term memory unit or buffer, which may be volatile or non-volatile.

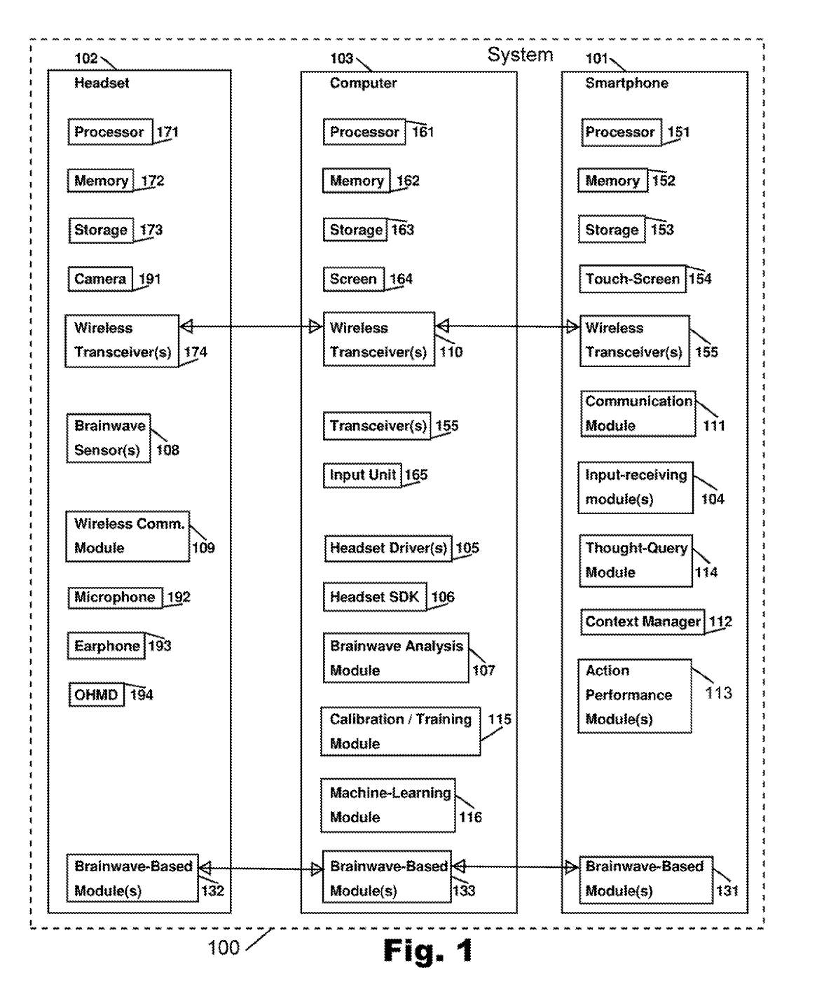

Reference is made to FIG. 1, which is a schematic block-diagram illustration of a system 100 in accordance with some demonstrative embodiments of the present invention. System 100 may comprise, for example, a smartphone 101, a headset 102, and a computer 103. Components of system 100 may communicate among themselves by utilizing one or more suitable wireless communication links and/or protocols, for example, BlueTooth, Wi-Fi, Wi-Max, IEEE 802.11 communications, IEEE 802.16 communications, or the like.

Smartphone 101 may comprise a suitable smartphone (e.g., Android smartphone, Apple iPhone, or the like), optionally utilizing a modified version of operating system, or an operating system augmented by one or more input receiving module(s) 104 able to receive as input commands that are based on analysis of brainwaves and able to act (or, to command other components of smartphone 104 to act) upon such received commands. Smartphone 101 may comprise one or more hardware components and/or software modules that are typically included in smartphones, for example, a processor 151, a memory unit 152, a storage unit 153, a touch-screen 154, wireless transceiver(s) 155, or the like.

Computer 103 may comprise a suitable computer or computing device (e.g., running Microsoft Windows, or Apple Mac-OS, or Apple iOS). Computer 103 may comprise headset driver(s) 105 and/or headset Software Development Kit (SDK) 106, as well as brainwave analysis module 107 in accordance with the present invention. Computer 103 may further comprise one or more wireless transceiver(s) 110, for example, in order to communicate wirelessly with smartphone 101. Computer 103 may comprise one or more hardware components and/or software modules that are typically included in computers, for example, a processor 161, a memory unit 162, a storage unit 163, a screen 164, an input unit 165, or the like.

In a demonstrative implementation, headset 102 may comprise a device having similar functions or properties to an Emotiv EPOC Neuroheadset, or other suitable headset or sensor(s) or electrode(s). In a demonstrative implementation, headset 102 may comprise electrodes or brainwave sensors 108, for example, 8 or 10 or 12 or 14 or 16 saline sensors or saline electrodes, such that the user may need to wet the sensors prior to wearing the headset), and may optionally comprise a wireless communication module 109 (e.g., a wireless dongle, or a built-in or external wireless transceiver) to wirelessly transfer data (e.g., to computer 103). Headset 102 may optionally include: a camera 191 able to capture video and/or images; a microphone 192 able to capture audio; an earphone 193 (which may also be referred to as a “whisperer”), or two earphones; and an Optical Head-Mounted Display (OHMD) 194. In some embodiments, one or some or all of the components that are described herein as implemented within computer 103, may actually be implemented within headset 102. In some embodiments, one or some or all of the components that are described herein as implemented within smartphone 101, may actually be implemented within headset 102.

Headset SDK 106 may match patterns in the EEG readings to the user's thoughts. The user may need to teach or train the machine learning algorithms used, to match his signals. The present invention may either use the SDK's user interface, or a proprietary interface for the teaching and calibration phase.

Brainwave analysis module 107 may apply logic with respect to the current context (state of smartphone 101) and thoughts detected (and their effects on smartphone 101). For example, in some implementations, it may be pre-set that the user would need to hold his thought of “open phone command” in his mind for a pre-defined period of time (e.g., one second), for the thought to be captured and acted-upon, in order to reduce or minimize false positive errors.

In some embodiments, headset 102 may not be capable of directly connecting to smartphone 101, and may only be able to connect to computer 103; and thus, headset 102 may be connected to computer 103 (using a wireless dongle or other wireless communication module 109), and computer 103 may transfer the commands to smartphone 101 over wireless link(s). In other embodiments, some or all of the functions that are described herein as functions of computer 103, may be implemented as features of smartphone 101 and/or as features of headset 102, thereby obviating the need to utilize computer 103 as a “device-in-the-middle” and allowing direct and un-aided communication between headset 102 and smartphone 101.

In a demonstrative implementation, smartphone 101 may be a Samsung Galaxy Nexus smartphone, or other suitable Google Nexus smartphone (e.g., Nexus 4 or Nexus 5). Such smartphones provide the source code needed for a developer to modify or customize the smartphone into a customized version of Android (with, or without, re-compiling the operating system). In a demonstrative implementation, smartphone 101 may comprise a communication module 111, a context manager 112, and one or more action performance module(s) 113.

Communication module 111 may be a service responsible for receiving notifications from computer 103 with user thoughts that were detected (e.g., user thought push), and transferring such notifications to other suitable modules in smartphone 101 to act upon. The communication may optionally be bi-directional, such that smartphone 101 may utilize a thought query module 114 to query the computer 103 and may “force” computer 103 to determine the user is thinking about (e.g., out of closed list of pre-taught or pre-trained thoughts). This may be used, for example, where smartphone 101 needs to know what is the user's though-reaction for an event. For example, if there is an incoming phone call, smartphone 101 may utilize thought query module 114 to initiate a query for determining whether the user desires to answer the call or to reject the call. In some embodiments, the SDK may not allow forcing a detection of the closest pattern, yet a particular implementation may force it by gradually changing the sensitivity of detection until a match is found.

Context manager 112 may track the context of smartphone 101. The context may be the sum of the different status of smartphone properties and usage(s). For example, whether or not smartphone 101 is currently locked is part of the context, and it has an influence on which effect has a cognitive action; for example, if smartphone 101 is currently locked then thought “A” might unlock it, but if smartphone 101 is currently unlocked then the thought may cause another result (e.g., open an email application on smartphone 101). Context manager 112 may be optional, as user-thought notifications may be transferred to different action performance module(s) 113 in smartphone 101 (e.g., such as an “unlock my phone” module), and each action performance module 113 may determine autonomously, based on its local context, how to act upon the incoming notification. Using the context manager 112 may provide more leeway and more functionality in some implementation; but the present invention may be utilized with a minimal set of features and in such case, optionally, without context manager 112.

Action performance module(s) 113 may comprise module(s) able to act upon receiving notification of user-thought(s). For example, in a demonstrative implementation, an “unlock my phone” module 115 may keep track of when smartphone 101 is being locked and unlocked, and upon receiving the relevant broadcast notification from communication module 111, the “unlock my phone” module 115 may unlocks the smartphone 101.

In some embodiments, translation of EEG signals into “identified user-thought” may be performed by machine learning algorithms which may learn and improve in this task for each particular user. The SDK 106 may provide an interface to calibrate and teach the algorithms the user-specific patterns of EEG. Optionally, actions may be used as trigger for thoughts. For example, system 100 may utilize a calibration and training module 115, which may be implemented as part of computer 103 (and/or headset 102, and/or smartphone 101) encourage a user to utilize actions such as push, pull, turn around, or other actions that are to be imagined (thought) by the user when looking at an on-screen object. For example, in a calibration screen the user may be required to imagine (namely, to think) how a floating box displayed on the screen may react to any of those actions.

The cognitive actions may be matched to smartphone actions with respect to the smartphone context. In some embodiments, the same action may be re-used in different situations for different meanings (or to achieve different goals). For example, the action “push” may be used to unlock smartphone 101 if it is locked, or it may be used to perform other actions (e.g., open the texting application) if smartphone 101 is already unlocked. After training the algorithms to detect several (e.g., four) different actions, system 100 may generate an initial user-specific profile (with the algorithms properties); and the SDK algorithm engine may be loaded with that user-specific profile. A machine-learning module 116 may continuously run (e.g., on computer 103, or on smartphone 101, or on headset 102) in order to improve the quality and/or the speed of determining user thoughts and/or correlating them to pre-taught patterns.

In some embodiments, machine-learning module 116 may learn on-the-fly, and may add new “user-thoughts” to a user-specific “dictionary” without requiring subsequent training sessions; and optionally, without utilizing any form of initial training or formal training session. The user need not perform any training or teaching session, with regard to the action of “launch the Angry Birds game on my smartphone”; however, the user may perform physical operations (e.g., finger gestures) that launch that game, accompanied by a specific or recurring though or through-pattern; and machine-learning module 116 may autonomously identify, that this particular thought or thought-pattern re-occurs every time (or, almost every time, or at 80% or 90% of times), just before the user launches that game. Accordingly, machine-learning module 116 may autonomously deduce that this particular thought or thought-pattern, is to be defined as an equivalent to “launch the Angry Birds game on my smartphone”; and subsequent utilization of the smartphone by that user may benefit from these machine-learned insights, without any formal training session or pre-teaching session for this particular thought.

In some embodiments, an initial or formal training session may be used, allowing the user to think a command (e.g., “unlock” or “unlock my smartphone”) several times (e.g., six times, or ten times); and allowing the system to capture and record the brainwave activity or EEG signals of those thoughts, and store them as reference signals; and in subsequent usage of the system, the system may capture brainwave activity signals and compare them to the reference signals, and may act on such signal if a match is determined, or if the currently-captured signal is sufficiently-similar or sufficiently-close (based on a threshold difference value, or based on a proximity metric) relative to any one of the previously-stored reference signals, or relative to at least two (or other threshold number) or more of the previously-stored reference signals.

In alternate embodiments, a formal an initial or formal training session may not be required, and the system may perform on-the-fly learning to correlate user thoughts with user actions (or with user-triggered actions, or with user-initiated actions or commands). For example, the system may continuously capture and record brainwave activity of the user; and may monitor interactions of the user with his electronic device (e.g., smartphone). The system may capture the brainwave signals of the user, that are emitted by the user's brain, immediately prior to performing an “unlock my smartphone” operation and/or during the performance of such operation (e.g., when the operation is triggered manually by the user's finger gesture on the touch-screen). The system may gradually accumulate several such “self-taught/self-deduced reference signals” of brainwave activity, that the system may correlate to that specific operation or command (“unlock my smartphone”), and these brainwave signals may be used as reference signals for subsequent brainwave interactions, instead of (or in addition to) reference signals that were captured in a formal training session in which the user was positively requested to think of a particular action or command.

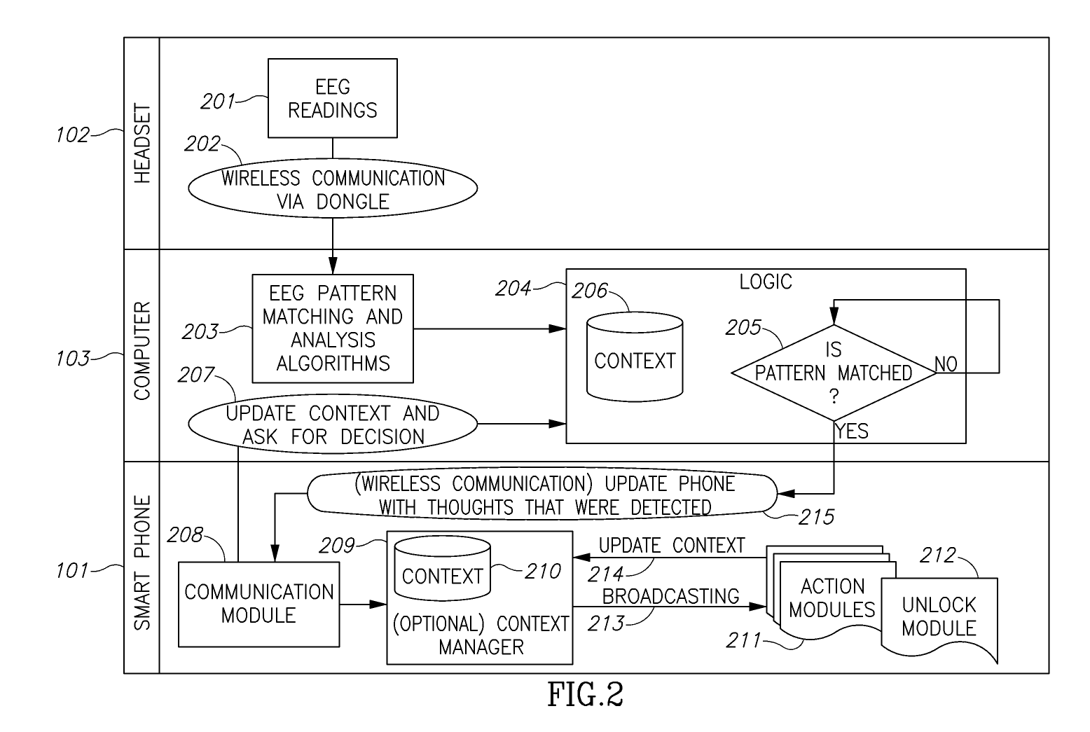

Reference is made to FIG. 2, which is a schematic illustration demonstrating interactions among the components of system 100, in accordance with some demonstrative embodiments of the present invention. For example, headset 102 may perform EEG readings (block 201), and may transfer the captured data (in raw format, or in down-sampled format, or in partially-analyzed format) over a wireless communication link (e.g., utilizing a wireless dongle, or a built-in or embedded wireless transceiver) to computer 103 (block 202) (or, in alternate embodiments, directly to smartphone 101).

In some embodiments, at any given moment, headset 102 records EEG signals of the user; for example, by utilizing the following demonstrative parameters: Sampling rate, or data collection rate of 2,048 samples per second per channel, filtered to remove electrical mains and harmonic frequencies and high frequency interference, then down-sampled to 128 samples per second per channel, optionally transmitted over a wireless link from headset 102 (e.g., to computer 103, or directly to smartphone 101). In some embodiments, effective user-thought detections may be updated several (e.g., two, or four, or six) times per second.

After the down-sampling, the data is wirelessly transferred from headset 102 to computer 103 (e.g., using a wireless transmitter of headset 102, and a receiver or receptive dongle which may be part of computer 103 or connected thereto) (block 202). Computer 103 may analyze the data, or may compare the data to pre-taught or pre-determined patterns, in order to detect specific thoughts (of actions), by using EEG pattern matching and analysis algorithm(s) (block 203). For example, logic 204 of computer 103 may continuously search for matched patterns (block 205), and may take into account context information (block 206).

Once a cognitive action is matched, computer 103 may use wireless communication to communicate with a communication module (block 208) of smartphone 101, in order to notify a service running on smartphone 101 that a cognitive action was detected in the user thoughts (block 215). That service may optionally utilize a context manager (block 209), which may be aware of the smartphone's context (block 210), in order to broadcast messages (block 213) to some or all of the action modules 211 on smartphone 101, indicating that an action was detected in the user thought. For example, if the predefined cognitive action that is used to “unlock” is detected, and as the “context” the smartphone 101 is in locked state, then the unlock module (block 212) unlocks smartphone 101; and the context is updated (block 214).

The unlock service is notified every time that smartphone 101 is locked and unlocked, and some implementations may allow multiple purposes to the same cognitive action, depending on the state of smartphone 101; for example, the same cognitive action used to unlock smartphone 101 may be used to achieve other actions if smartphone 101 is already unlocked.

Referring again to FIG. 1, in alternate embodiments, headset 102 may be adapted to perform partial, preliminary and/or full analysis of EEG data and/or brainwaves, instead of (or in addition to) such analysis being performed by computer 103 and/or by smartphone 101. For example, headset 102 may comprise a processor 171, a memory unit 172, a storage unit 173, and wireless transceiver(s) 174 (e.g., utilizing Wi-Fi, BlueTooth, or the like). Processor 171 may run code able to distinguish, identify or detect meaningful though patterns from the captured signals; or to translate brain signals to meaningful cognitive actions/thoughts. Such implementation may optionally obviate the computer 103, and may allow headset 102 to communicate directly with smartphone 101; optionally in bi-directional communications, allowing headset 102 to “push” user-thought notification(s) to smartphone 101, and/or allowing smartphone 101 to query or poll the headset 102 for a current or most-recent user-thought. Partial or full performance of the user-though analysis in the headset 102, may allow system 100 to include, instead of a powerful smartphone 101, a less-powerful cellular phone, or a less powerful handheld device that does not necessarily have high-end resources (e.g., processing power, memory).

The present invention may trigger an action on smartphone 101 based on pattern matching from the user's EEG readings as captured by headset 102. This may be used for various use cases, for example, to navigate through menus, to browse email messages, to browse the Internet, to open or close applications, or the like.

In alternate embodiments, smartphone 101 (or other suitable electronic device instead of smartphone 101), may have sufficient resources (e.g., processing power, processing speed, memory, storage capacity, or the like), to allow smartphone 101 to receive from headset 102 raw or partially-analyzed EEG signals (or down-sampled representations of brainwaves), and to perform some or all of the user-thought identification process within smartphone 101, and not externally to smartphone 101 (namely, not in headset 102, and not in computer 103).

Some embodiments match patterns in the EEG samples to patterns that were recorded when the user was thinking on an action (cognitive action). Other embodiments may use an algorithm to match not only patterns of EEG that represents thoughts, but patterns of EEG that indicate concentration, recalling or remembering, or any other type of analysis that may be correlated to EEG (and not necessarily patterns that represents thoughts). For example, smartphone 101 may autonomously “unlock” when headset 102 senses and/or determines that the user is focused or concentrated; and smartphone 101 may autonomously “lock” (or pause an activity) when headset 102 senses and/or determines that the user is unfocused or non-concentrated. This may further be beneficial to improve battery life and for efficient battery consumption of smartphone 101, and of other electronic devices (e.g., portable or wearable computing devices, devices having Head-Mounted Display (HMD, or the like).

In some systems, a wearable computing device may utilize a means to project visual output to the user's field of view, for example, by projecting to the user eye, or using close to the eyes semi-transparent screen. Such visual output may sometimes block or interfere with the normal field-of-view of the user; and the user may not necessarily desire to be shown the visual output of the device all the time (e.g., as it may interfere with his normal visual input, or may drain the battery of such a device, or for other reasons). In accordance with the present invention, such device may support an autonomous “lock” (or pause, or suspension, or stop) which occurs when one or more user-thought conditions are detected, or when a particular brainwave pattern is identified (e.g., indicating user dissatisfaction, user anger, user boredom, user fatigue, or the like).

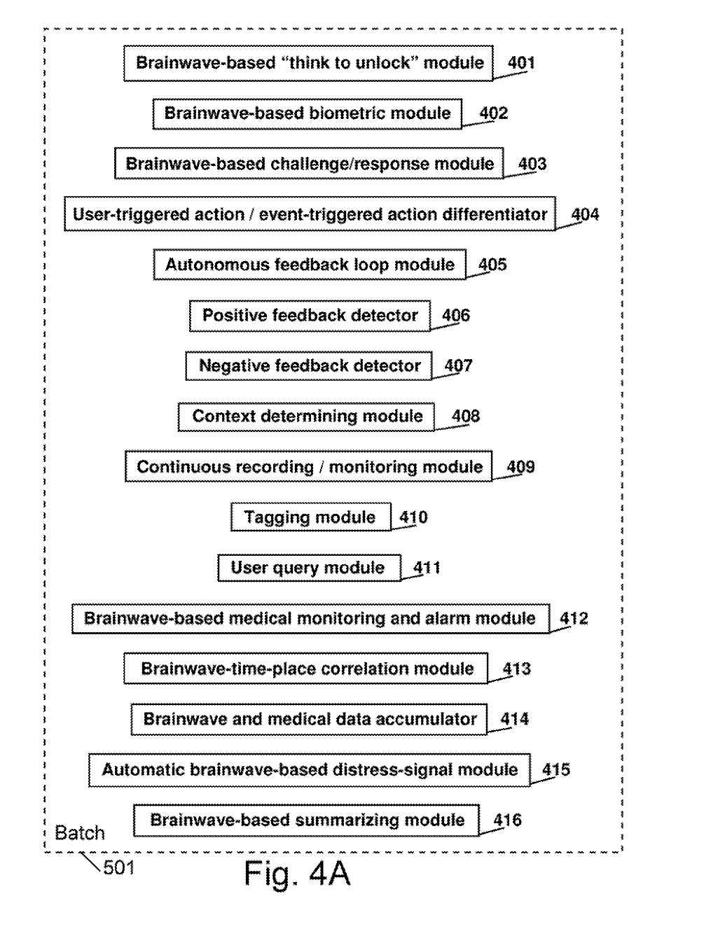

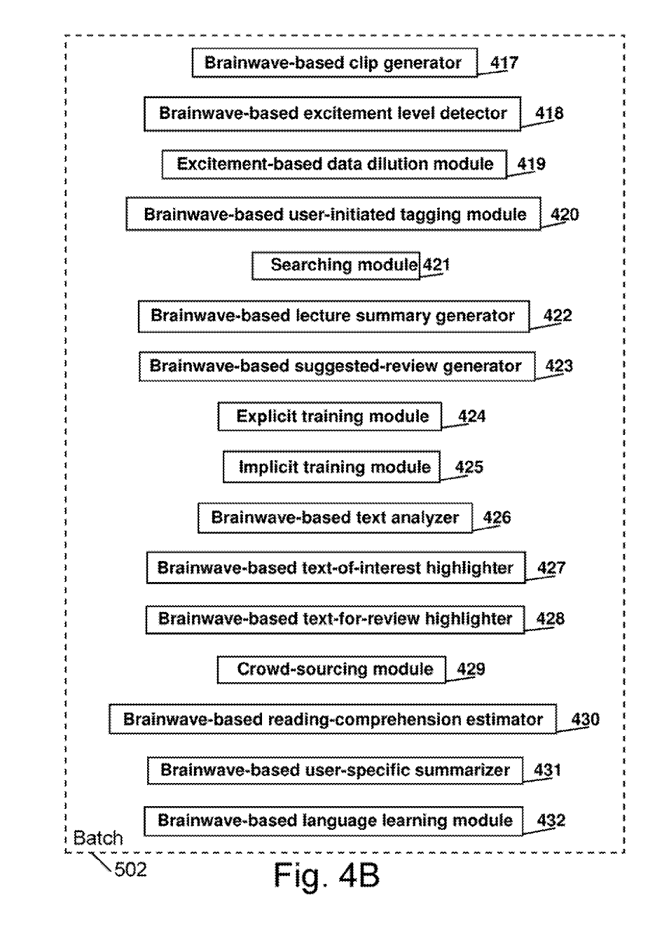

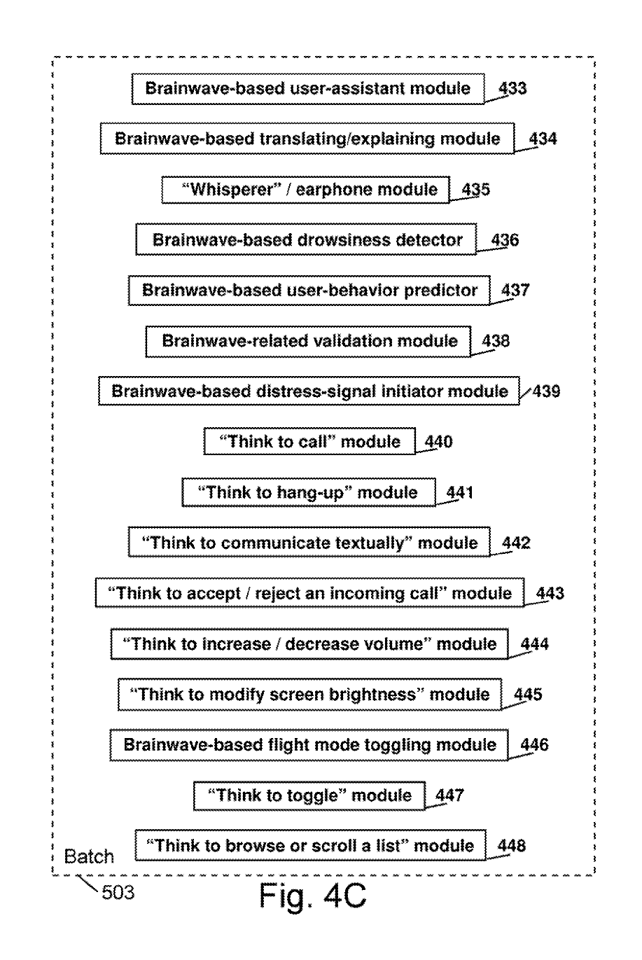

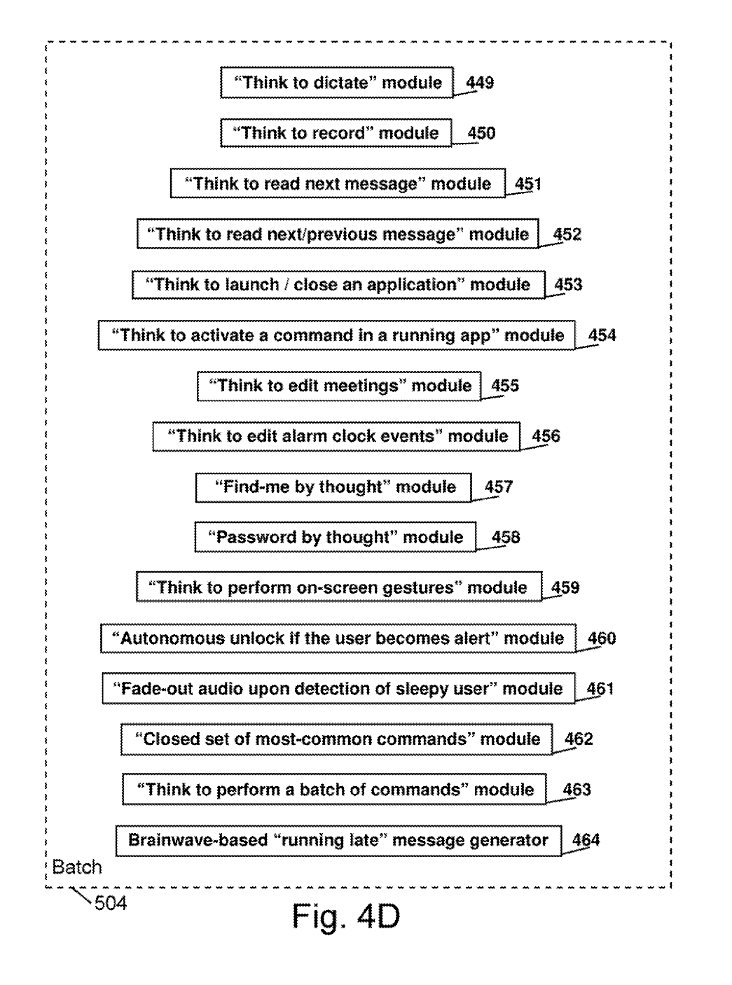

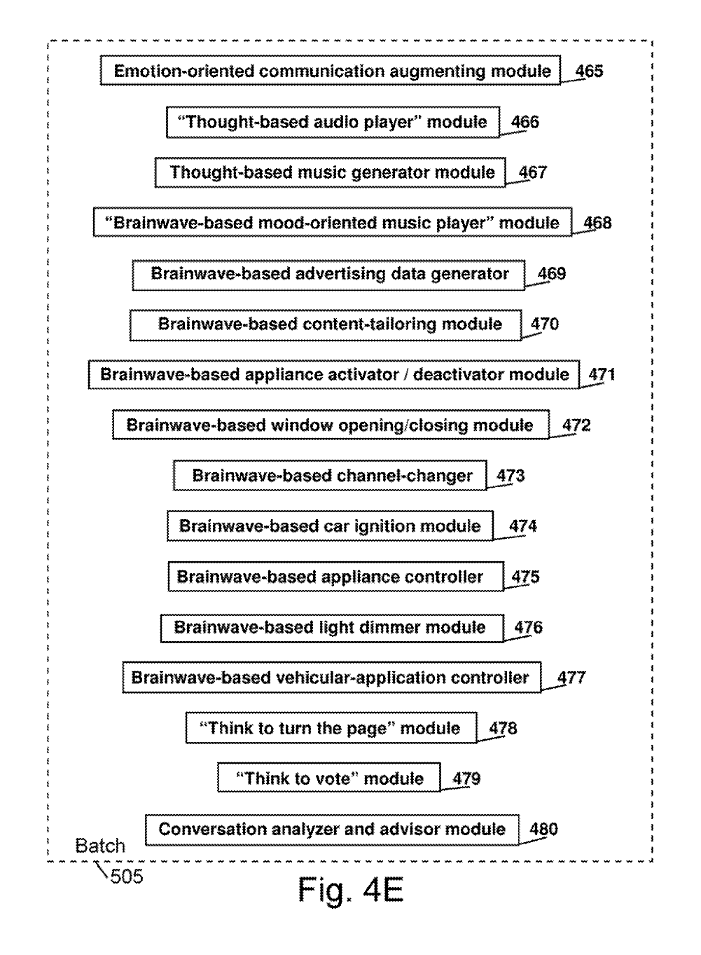

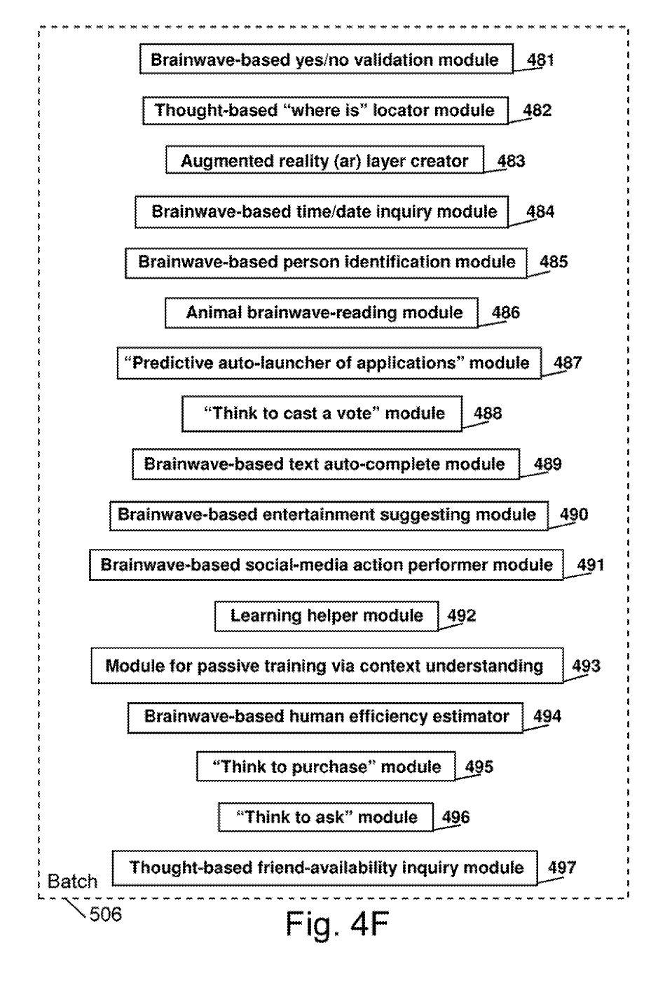

In some embodiments, smartphone 101 may comprise brainwave-based module(s) 131. Additionally or alternatively, headset 102 may comprise one or more brainwave-based module(s) 132. Additionally or alternatively, computer 103 may comprise brainwave-based module(s) 133. In some implementations, brainwave-based module(s) 131-133 may perform one or more operations, described above and/or herein, with regard to capturing and/or storing and/or analyzing brainwave activity of a user, or matching or comparing such brainwave activity to prior brainwave activity or to a “reference” brainwave activity (e.g., captured and stored as a reference signal during training-phase or calibration-phase or learning-phase). In some embodiments, brainwave-based module(s) 131, and/or brainwave-based module(s) 132, and/or brainwave-based module(s) 133, may comprise one or more modules and/or functionalities that appear in FIGS. 4A-4F, and/or that are described herein with reference to FIGS. 4A-4F.

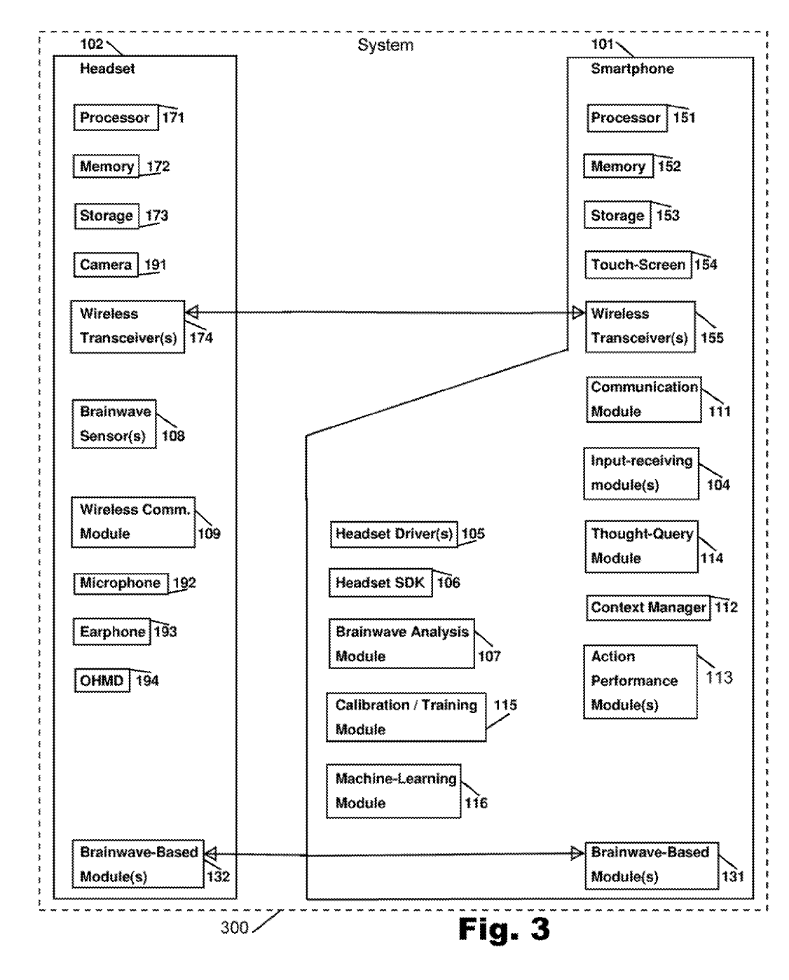

Reference is made to FIG. 3, which is a schematic block-diagram illustration of a system 300 in which the headset and the smartphone communicate directly, in accordance with some embodiments of the present invention. As demonstrated in FIG. 3, computer 103 may no longer be needed to assist in communications between headset 102 and smartphone 101, which may now directly communicate between them. Some of the modules and functionalities that were shown in FIG. 1 as belonging to computer 103 (such as, for example, headset driver 105, headset SDK 106, brainwave analysis module 107, calibration/training module 115, and machine-learning module 116), may be included in smartphone 101 (or, in another implementation, they may be comprised in headset 102; or they may be distributed across the two devices, namely, smartphone 101 and headset 102).

The principles and/or components of the invention may be utilized to achieve various goals, or to provide various features or functionalities that do not exist in conventional systems. The following description demonstrates such features and functionalities of the present invention, described as discrete “use cases” or “implementations” or “embodiments”; which may optionally be combined together or may be used in concert, in some implementations.

Reference is made to FIGS. 4A-4F, which are schematic illustrations of batches 501-506 of brainwave-based (or brainwave-related) modules or functionalities, in accordance with some demonstrative embodiments of the present invention. Each one of modules 401-497, or some or all of such modules, may be implemented as part of any of modules 131, 132 and/or 133 which appear in FIG. 1 and/or in FIG. 3.

In a demonstrative use case, the present invention may be used to provide enhanced security and/or built-in security and/or integrated security. For example, the “think to unlock” mechanism described above may be implemented by a brainwave-based “Think to Unlock” module 401, which may also encapsulate a security feature; since the EEG readings are biometric information which is unique to the user. Therefore it is very unlikely that someone who is not the user may be able to unlock the device, and thus the device provides protection against being unlocked by people who are not the authorized user of the device. Accordingly, a brainwave-based biometric module 402 may be used, in order to identify a user and/or to authenticate a user, or in order to utilize EEG reading(s) or brainwave pattern(s) as a username or as a password, or as part of a log-in process. This feature may be used as an authentication means, since many different users may train the system to recognize their EEG readings, and then when they try to unlock the device it may find which user has the most relevant EEG patterns and thus authenticate the current user as this person.

It is noted that in the “Think to Unlock” feature described above, as well as in other brainwave-based features described herein, the system may utilize various types of thoughts to achieve a particular goal. For example, the user may train that system that thinking of the word “unlock” will cause unlocking of the smartphone; or, that thinking of an image of a key unlocking a door (or unlocking a treasure chest) will cause unlocking of the phone; or even, that thinking of a peculiar word or image (e.g., the phrase “strawberry ice cream”, or an image of an elephant playing guitar) will cause unlocking of the smartphone. The present invention may allow such flexibility, to allow users to utilize the think-to-command mechanism of the invention in a most convenient manner to them.

In another demonstrative use case, the present invention may be used for advanced security as a part of a challenge/response scheme, by using a brainwave-based challenge/response module 403. If one wants to improve security, it is possible to add one or more iterations of challenge response. In that case the flow may be as following: User thinks (about an idea, object, or a cognitive action); user's EEG pattern is analyzed and matched to the pattern needed to trigger unlock operation; the device challenges the user to think on one out of predefined thoughts (for which the system may match their pattern). If the user is able to produce the needed EEG readings (by thinking of the idea, object, or cognitive action) then the challenge is responded correctly, and the next challenge may be sent until no more challenges are needed and the device may be unlocked (or, another operation that requires authorization, may be authorized to proceed and be performed).

In another demonstrative use case, the implementation may distinguish between: user-triggered actions, and event-triggered actions. On the first scenario, the algorithm needs to distinguish between idle state (the user does not want any mind controlled action to happen to the smartphone) and actions that should control the smartphone (e.g., unlocking the phone, starting application); whereas, in the second scenario, the user needs to take an action in response to an event that happened on the smartphone. This differentiation may be useful for other scenarios, and may be implemented by using a user-triggered action/event-triggered action differentiator 404. For example, if the user may decide between answer/ignore an incoming call using his thoughts, when a call is received, it is more likely that the user is choosing between those three actions (Answer/Hang up/Idle—did not think anything meaningful yet) than any other action that the system is trained to detect. This information may be used to improve the results of the algorithm responsible to extract the meaning out of the EEG reading when the call is received.

In another demonstrative use case, the invention may supervise or augment learning feedback, by using an autonomous feedback loop module 405. Matching between signals and meanings (e.g., matching between signals to patterns that have logical meanings) may be based on machine learning algorithms, which may require an initial calibration period; some algorithms may improve if they are provided with feedback with regards to their output (e.g., if the user may inform the algorithm when it was right or wrong, then the algorithm may dynamically update its parameters and provide better output in subsequent iterations). The system may provide feedback to the algorithm, about its success or failure in classifying user thoughts from the patterns found in the signals; and thus may provide better success rate in “reading the user's mind” and thus providing better and more accurate user experience.

Feedback may be in the form of confirmation (e.g., positive feedback) or in the form of correction (e.g., negative feedback). For example, positive feedback detector 406 may detect positive feedback, if the smartphone was unlocked because the algorithm classified the signals as “unlock phone thought” and the user started to operate the smartphone shortly thereafter, then this may be an indication that the user had indeed wanted the smartphone to unlock. Alternatively, negative feedback detector 407 may detect negative feedback, if the smartphone was unlocked because the algorithm classified the signals as “unlock phone thought” and the user immediately locked the smartphone without taking any other action, then this may be an indication that the user had not meant to unlock the smartphone. The algorithm that matches user-thoughts to pre-defined cognitive action(s), may be updated or modified or enhanced or fine-tuned, based on such positive feedbacks and/or negative feedbacks.

In some embodiments, the device may be controlled based on thoughts of a user, the thoughts corresponding to concrete or specific commands that may be common in the context of usage; and a context determining module 408 may be used to determine the particular context in which the user-thought should be acted on, or, context determining module 408 may determine which interpretation of an otherwise-ambiguous user-thought (which may be translated into two or more possible commands) should be selected and acted upon. For example, the user may think “scroll the list down” or “launch the mail application” or “open the calendar application”, and the device may perform the corresponding command. In other embodiments, the system may be trained such that a thought which may be abstract or semi-abstract, or not necessarily be related to the operation of the device, may still be captured and acted upon in the context of the device. For example, the user may think “up”, which is a thought not necessarily unique to the context of the operation of the device, and the system may capture this thought and may cause the relevant device to perform a suitable operation, for example, scroll up a page or a list. Similarly, the user may think “open” which may be an abstract or semi-abstract thought, and the system may capture and act upon this thought, for example, by “opening” an attachment in an email message.

The following discussion describes some demonstrative features of the present invention, that may be implemented by using a system with a continuous recording/monitoring module 409 of brainwaves or other bodily signals; for example: systems that continuously collects inputs (from Microphone, EEG, Brain Waves, GPS, Thermometer, sweat level, heartbeat, or the like), store the data locally or remotely (e.g., in a Cloud computing device or storage), or other local or remote medias (e.g., hard disk drive, Flash memory, local storage unit, smartphone, cellular operator, cellular service provider, or the like), and may generate information, warnings or alerts to the user when the array of data suggest such information or alert is relevant. For example, if the system recognizes that the user is sleepy while driving too fast, then the system may provide an alert. Or, the system summarizes the parts of a lecture where the user was the most alert and concentrated, and sends the summary to the user via email (or, files the selected summary in the user's cloud storage or local storage).

In a demonstrative implementation, the system may record brain activity and a set of inputs, and acts based on these inputs. The system may record a user's brainwaves, heart beats, audio and video at user surroundings (e.g., an array of inputs from different sensors). The system continuously learns patterns in the inputs, and a tagging module 410 may tag or mark or save “interesting” records from all these inputs, and may optionally alert the user in certain situations. For example, the system may record in parallel: audio captured by a wearable or portable microphone; video and/or images captured by a wearable or portable camera; brain waves or brain activity data captured by a helmet or electrodes or one or more head sensors; one or more biometric data (e.g., heart rate, blood pressure, sweat level, adrenalin level); and/or environmental conditions (e.g., environmental temperature, air pressure, altitude). The system may perform image recognition and/or video analysis and/or audio recognition (e.g., speech to text), to identify key events or non-conventional occurrences or interesting events or other events defined by the system or by the user as events-of-interest. The system may tag or mark the data portions, captured across multiple sensors, which correspond to such interesting event.

Upon user request, conveyed by the user through a user query module 411, the system may subsequently retrieve sensed data that corresponds to one or more tagged events, and may present or playback to the user images, video and/or audio corresponding to such requested events. Such system-selected data may be presented to the user, for example, via the same device that captured the data (e.g., a smartphone, a tablet, a laptop, a Google Glass device, an augmented reality device), and/or may be exported or transferred to another device for playback or presentation purposes (e.g., via a television set or a computer monitor).

In another demonstrative implementation, the system may operate as a medical monitoring and alarm system, by utilizing a brainwave-based medical monitoring and alarm module 412. The system recognizes if the user's brainwaves are irregular, or if the user's pulse is too high or irregular, or if the user is sweating excessively; and the system provides warning about the situation and suggests a remedy; for example, “Your heart beat is too high, recommending that you sit down and drink water”, or, “the system detects that you sweat excessively, recommending that you drink cold fluids and relocate to a colder room”.

For example, the system keeps collecting and records and analyzes data from a set of sensors in parallel: audio captured by a wearable or portable microphone; video and/or images captured by a wearable or portable camera; brain waves or brain activity data captured by a helmet or electrodes or one or more head sensors; one or more biometric data (e.g., heart rate, blood pressure, sweat level, adrenalin level); and/or environmental conditions (e.g., environmental temperature, air pressure, altitude). The system may optionally perform image recognition and/or video analysis and/or audio recognition (e.g., speech to text), in order to identify key events or non-conventional occurrences or interesting events or pre-defined events-of-interest. The system uses this ongoing data acquisition to learn what is the normal pattern of inputs from the user in regular activities (e.g., what are the inputs most of the time), and to deduce what are abnormal or irregular user inputs or user conditions; for example, identifying what is the usual blood pressure and pulse rate of the user; or what are the Theta brainwave rhythm and other brainwave pattern of the user most of the time.

The system may utilize a brainwave-time-place correlation module 413 to correlate different types of inputs to different situations and activities of the user, or to the particular time or location of the user at the brainwave reading. For example: a rise in the pulse may be identified as a result of exercise in the gym. The system may learn that at certain hours in certain days, the user goes to the gym. It may correlate this data with the GPS position of the user (being at the gym), or with the user's calendar application indicating a visit to the gym. And so, the system may learn repetitive patterns of activities by the user at work, at home, at the gym, or the like. This may be an ongoing learning process from the minute the system is turned on by the user and onward. In parallel to the monitoring process, a process that checks if the current inputs from the system sensors fit one of the regular situations may also be constantly checked.

The system may utilize a brainwave and medical data accumulator 414 to accumulate (e.g., for subsequent or real-time usage by a medical team, or by the user himself), data about the user's brainwave and other physical activity and state; and may tag the data according to different situations (e.g., “at the gym”, “at work”, “at home”, “sleeping”). These records may provide critical and valuable data for analyzing and treating emergency situations if the user may be in such a state. In some embodiments, irregular parameters that are sensed, may be set aside or discarded based on location-based information or based on user approval; for example, if GPS positioning data or other location-based information indicate that the user is at a gym or a fitness center or a soccer field, then, optionally, fast heart-beats and/or increased sweat may be regarded as normal for that location and may not trigger an alarm, or may trigger a request for user confirmation that all is proper.

In addition, if and when irregular inputs are identified, which show that this is not one of the regular situations by the user and that this might have alarming situation, then the system may activate a “medical alarm” process, and may activate a set of operations to alarm the user, and close family if he so pre-defined, of the user's alarming situation. For example, if heartbeat rate is higher than normal at work (and system recognize the user is now at work), or higher than the level they usually are during gym (and system identifies the user is at the gym now), then the system may initiate an alarm such as a beep, a textual message and/or audio alarm. The system may also send an SMS or email or text message to a list of contacts that were defined as relevant contacts such as: spouse, parent, sibling, physician, hospital, 911 operator, first responder(s) system, or the like.

Some implementations may provide an Auto-SOS alarm system, or an automatic brainwave-based distress-signal module 415. The system recognizes the user is in distress or in high-risk situation or a medical emergency (such as: High-heart rate, Stroke condition, high blood pressure, user fell on the floor and does not move), the system may alarm the user of his condition as well as send distress message (via SMS, email, phone call, to an emergency center or to pre-defined recipients) informing about the user's identity and condition (with the relevant data the system has) as well as GPS location of the user. The system may locate people from the user's contact list on his smartphone (or from a user-defined distress-recipients list) that are geographically close to the current location of the user, and may inform them of the SOS situation, by phone or by SMS or texting or other means.

Some implementations may brainwave-based summarizing module 416, in order to tag or mark moments in time or events that may be of interest for a subsequent review or for summary creation. The system records with a microphone (and possibly other sensors such as: video camera, GPS position, pulse rate, or the like) the user's activities, and automatically adds labels or tags on “interesting” events or times during the day, based on the user's state of mind (e.g., happiness, concentration, being focused, being bored, showing interest, showing non-interest, yawning, participating in a conversation). For example, the system may record in parallel: audio captured by a wearable or portable microphone; video and/or images captured by a wearable or portable camera; brain waves or brain activity data captured by a helmet or electrodes or one or more head sensors; one or more biometric data (e.g., heart rate, blood pressure, sweat level, adrenalin level); and/or environmental conditions (e.g., environmental temperature, air pressure, altitude). The system may optionally perform image recognition and/or video analysis and/or audio recognition (e.g., speech to text), in order to identify key events or non-conventional occurrences or interesting events. The system may tag or mark the data portions, captured across multiple sensors, which correspond to such interesting event.

Upon user request, the system may utilize a brainwave-based clip generator 417 to subsequently retrieve and/or summarize sensed data that corresponds to one or more tagged events or tagged state-of-mind, and may present or playback to the user images, video and/or audio corresponding to such requested events or state-of-mind. The system may, for example, create a short summary from a three-day vacation showing video, audio and other data from the sensors that recorded the events only at the times that user's brain activity recordings show that the user was excited, happy, enjoying; or may summarize the top five minutes in those three days in which the user's signals indicated the highest level of excitement or concentration.

The user may command the system to create a summary (e.g., a five-minute summary, a ten-summary, a one-hour summary) of the longer-period event (e.g., a four-day vacation or trip), and the system may utilize tagging of brainwave patterns and/or other suitable indicators, to select the most exciting or interesting portions of the recordings and organize them, by searching or filtering or sorting the level of user's excitement (or interest) in each part of time (e.g., analyzed by using one-minute time intervals or “slices” of the event); so that the total resulting audio/video clip would be within the user-requested time limit. Such system-selected data may be presented to the user, for example, via the same device that captured the data (e.g., a smartphone, a tablet, a laptop, a Google Glass device, an Augmented Reality device), and/or may be exported or transferred to another device for playback or presentation purposes (e.g., via a television set or a computer monitor, or to a cloud computing server or device or storage area).

In some embodiments, the system may present user with the happiest moment(s) or minute(s) in the vacation. A camera or camcorder records continuously all the visual experiences (and a microphone records the audio); and after the vacation, the system finds and highlights the moments during which the user was happiest or most excited, and tags these points in time for a summary of “My vacation's most exciting moments” summary video clip.

For example: the audio/video recording is performed by an Augmented Reality (AR) device or glasses (e.g., Google Glass) or by wearable or external camcorder and/or microphones. The data is accumulated during the vacation, stored locally in a memory unit, or transmitted to a nearby device (smartphone or laptop), or to a remote device (a cloud-based server or storage device). Efficient data transfer may be utilized, so that the most important happy moments (that are identified, in real time, by the brain pattern of the user at that time) may be stored separately from the other, less happy data, to provide easier access or faster access to the most relevant data; optionally by utilizing a brainwave-based excitement level detector 418.

Optionally, locally-stored data may be periodically purged or diluted or discarded or deleted, to save (or re-use) storage space if needed, by deleting or discarding audio/video data corresponding to un-interesting time periods (the user is sleeping or the user is bored now), and by keeping interesting time periods (the user is skydiving) only, by utilizing a brainwave-based excitement-based data dilution module 419.

The system may allow the user to say a code, or to think a code, like “keep this event” or “store this event”, or “include this event in the summary”, to indicate that it is interesting and should be kept; or to say/think “discard this event” to discard it. For example, a brainwave-based user-initiated tagging module 420 may be used to capture and identify such user-thoughts, and to tag or mark slices of the captured audio/video with the corresponding tags. In case of user command, the system may perform the command by the user, regardless of its own automatic analysis of the data. For example, if the user is skydiving and brain activity show he is very happy now, but user commands “do not keep this”, then the system may regard this part of the recording as not suitable for keeping in the “Happiest moments” of the vacation, as the user's thought may be regarded as over-riding the system's determinations.

The system may allow the user to search or scan the data of past times (e.g., using a searching module 421) and order the system to prepare a summary of specific time interval(s); for example, from Tuesday morning until Thursday evening, or “from all of last week vacation since we left home until we returned home”. The user may indicate to the system how long the summary should be: All the interesting parts, or only “the most interesting parts”. The user may also define how long the summary should be (e.g., ten minutes, one hour). Based on instructions from the user, the system may produce the “Most happy/exciting moments” audio/video summary clip. By sorting different times-intervals according to the level of user happiness or excitement, the system may select the “top most interesting parts” and may not include parts that are less interesting and are exceeding the total time span that the user commanded.

Some implementations may utilize a brainwave-based lecture summary generator 422, in order to determine and compile a summary of the most interesting parts in a lecture, by using methods similar to those described above. The system tags and selects moments in a lecture that the user attended, in which the user's brainwaves indicated that the user was alert or interested or concentrated; and optionally, discards lecture portions in which the user brainwaves indicated boredom, sadness, anger, or the like.

Optionally, when learning a new subject, by either attending a lecture, watching online video, listening to an audio clip or audio lecture, or other suitable ways, the system may summarize and highlight parts that the user needs to review again; by utilizing a brainwave-based suggested-review generator 423. The system may detect when the user is intrigued, curious or confused, either explicitly, or by implicit training.

In explicit training, the user may use a designated application (e.g., an explicit training module 424) that may make the user feel in a certain way (e.g., “confused”) and may log the user's brain activity and/or face muscles activity. The algorithm may extract a distinguishable pattern that may later be used to determine if the user is in one of the trained moods (e.g., “is the user confused”).

In implicit learning, the system may utilize an implicit training module 425 to determine the user's feelings or emotions without asking the user to do anything in particular; for example, the system may track and observe that the user is repeatedly playing the same portion in an online video lecture, and thus deduce that the user is confused or does not understand that portion. The system may then learn and extract meaningful patterns from the logged brain activity and face muscle status.

Once the system knows how to decipher a user's feeling and status with respect to new material that the user is trying to learn, the system may aid the user while the user is trying to learn new subjects. For example, the system may detect when the user is sleepy or unfocused, and record or mark all the parts in a lecture where the user was not fully concentrated. The system may mark or record all those parts which the user thought were important, by matching the lecture with the brainwaves readings that show the user was most alerted and intrigued. Such selected segments may then be compiled into a summary clip, aiding the user to re-review particularly those segments for better understanding.

In some embodiments, the system may utilize a brainwave-based text analyzer 426 in order to identify and/or summarize interesting parts in a text that the user reads. Based on brainwave activity, the system may tag or labels the text that the user reads: which paragraphs the user likes the most, or in which paragraphs the user was most concentrated while reading them, or were most difficult for the use to read and/or to understand. The processed text may be saved for subsequent usage, for example, for re-reading all the highlighted paragraphs that were most interesting to you in the text (or alternatively, for re-reading the paragraphs that were the most difficult at first reading), based on brainwave activity.

For example, while the user is reading a book or magazine or article, the system may records the brain activity continuously, and also captures the text of the book being read; the device camera follows the user's eye movements. The system may correlate (online, or in real-time, or at a later stage in time, offline) between brain activity that indicates that the user is very interested, with the relevant text portions that the user read at these same moments of this brain activity. At a result of this correlation, the system may highlight the parts in the original text that were interesting to the user (according to the criteria mentioned above). The resulting output may be the complete original text, with the interesting parts highlighted in it (in bold or italic, or color marker, or by special font type or font size); for example, by using a brainwave-based text-of-interest highlighter 427.

Alternatively, the system may utilize a brainwave-based text-for-review highlighter 428, to select or highlight or summarize the portions of text in which the user was less-interested or less-focused, and which may be useful for re-reading or re-reviewing by the use for various purposes (e.g., if the user indicates to the system that the user is preparing for an examination, and thus requests to re-review portions of text in which he was no focused).

Optionally, the system may remove the “uninteresting” parts of a text, e.g., the parts where the user was not interested while reading them; and may output only the “interesting” parts of the text, based on brainwave analysis. This output, in any suitable format, may be saved as a file, or sent as an email, or saved in a list of texts the user asked to summarize this way (including the time the text was read, and textual or audio or video remarks by the user). This output may be used by a website or application that keeps lists of books and essays, or by a social network website or application (e.g., Facebook).

Optionally, a crowd-sourcing module 429 may be used to leverage the “wisdom of the crowd” and to aggregate summaries of books or articles that many users read; such that a new user that did not read a specific book, may get access to the summaries of this book that were generated by the user's friends on the social network, or see different summaries produced by strangers. Optionally, such brainwave-based summaries of texts (or of audio/video lectures) may be available for search and reading (and rating or commenting) by other users, in an online library or repository website.

Some implementations may generate an automatic summary of texts being read by the user, based on properties such as: how fast the user you moved thought the text, and/or the level of the user's concentration during the reading of certain paragraphs, or the like; by using a brainwave-based reading-comprehension estimator 430. While the user reads a text (book, digital book, SMS, text message, article, or the like), the system may track and monitor an array of inputs: brainwaves, eyes movements, head position, or the like. Based on these inputs, the system may determine how fast/slow the user went through the text, as well as how concentrated the user was at each part of the text. The system may then summarize or highlight portions of the text, based on these inputs; giving more attention and length to summarize the parts in which the user was most concentrated while reading, while giving very short summary to parts in which the user seemed to skip or read very fast and/or that the user was not concentrating on them while reading them. This may allow the system to utilize a brainwave-based user-specific summarizer 431, to generate a user-specific summary of a text (or an audio clip, or a video clip) that matches the user's personal preferences about the text.

In another implementation, the user asks the system to summarize the parts in the text that were less clear to the user, or that he was not concentrated enough while reading them; and the system, based on analyzing the brain waves, as well as eye movements and head position of the user, and optionally other parameters (e.g., the time it takes to read a sentence, or, two or more attempts to read the same sentence or the same paragraph), may provide a more elaborate summary of the text portions that the user had read too fast or was not concentrated while reading them. Such user-tailored summary may help the user complete his understanding of the text after the first reading. In some embodiments, rapid eyes movement may be captured and may indicate fast reading of the current text; whereas slow eyes movement may indicate slow reading; and brainwaves may further indicate how concentrated the user is at the current text-portion that he is reading (or listening to, or watching).

Some implementations may utilize a brainwave-based language learning module 432, to assist a user to learn a new language. The system may monitor and learn weak vocabulary words or other language-related difficulties of the user (e.g., pronunciation of certain words, comprehension of certain words) by analyzing the user's brainwave activity in correlation with what the user hears or says. The system may then determine which words or phrases or sentences the user finds hard to understand or need to repeat, and the system may repeat them for the user (or may otherwise explain or translate or help the user) until the user is proficient.

Accordingly, some implementations may assist the user to learn a foreign language. The system may measure a user's brainwaves to decide whether the user understands what he hears or not. Moreover, the system may determine whether the user's brain is using areas associated with first or with second language. Using these abilities, the system may manage and assist the language acquisition process. For example, the system may use speakers to read to the user words in the second language, until the user's brain accept these words as it does for first language words. The system may focus on new words, and occasionally may test if the user still remembers these words. For example, the system may repeatedly read a word and its translation; since the invention is doing the management (e.g., decides when to move to the next word), this process may be done without the user's active intervention, based on brainwave analysis indicating that the use comprehends and/or remembers; and optionally, this may be done while the user is doing other things, or even sleeping, as long as his brainwave activity indicates comprehension and/or memorization of the new word, or indicates that a word spoken in the first language causes similar or identical brainwave pattern(s) to a word spoken in a second language.

Some implementations may utilize a brainwave-based user-assistant module 433, to monitors a user's understanding of new things and to provide the user with help and guidance accordingly, on a user-specific tailored basis. The system tracks user brainwaves to determine which part(s) of a lesson or lecture or book or article or study-unit the user understood, and which part(s) he did not understand. Based on the records accumulated doing user's activity (reading a book, sitting in a lecture, or the like), the system may point to and instruct the user how to improve his understanding of the material he read or listened to, and specify, which parts (in the book or lecture) the user should re-read or re-listen to in order to fully understand them.

For example, the user attends a lecture, and the system records the audio of the lecture and the user's brain activity during the same time. The system may then present to the user, at a later time and/or when the user commands it, a playback of parts in the lecture that it appears that the user did not understand, or was not concentrated. Optionally, a machine-made explanation of key words, or challenging words in this part of the lecture may be obtained by the system and presented to the use; e.g., the first paragraph of a Wikipedia article for a difficult word or term that the user did not understand; or dictionary explanation or dictionary translation of such word into the user's native language or preferred language that was pre-defined to the system by the user. The system may keep track of the parts of the lecture that the user replayed, and/or the words that the user checked for their translation or Wikipedia explanation; and may use this info to suggest a training session or test session to the user about the lecture.

Some implementations may utilize a brainwave-based translating/explaining module 434. The user may set the system to “translate mode” (and optionally, specifies default languages for translation). When the system recognizes a word or phrase or sentence in the specified foreign language, the system may automatically provide to the user the translation or explanation in a user-preferred language. The translation or explanation may be provided to the user via a “whisperer” component 435 (e.g., an earphone, or two earphones), or may be displayed or projected on a HIVID or OHMD or screen. Optionally, the user need not specify which language is being spoken, and the system may recognize it automatically. Optionally, the user need not specify to which target language a translation is desired, and the system may determine it automatically based on recognition of prior utterances of the user in his language. Such “whisperer” component may be or may include, for example, one or more earphones or miniature speakers, which may be placed in (or on, or near) the ear(s) of the user, and may be used to provide the user with audio feedback, audio input, audio information, as well as other types of audio signals which may otherwise assist the user, in this implementation and/or in other implementations described above or herein.

Some implementations may utilize a brainwave-based drowsiness detector 436, in order to generate a “you are sleepy/drowsy” alert or warning message. For example, the system may monitor head position and/or EEG readings and/or other parameters, and alert the user (or send alerts to third parties) if the user gets too drowsy or sleepy or un-concentrated or unfocused. The system continuously monitors the user's brainwaves, head position, and other inputs from the user's behavior and the surroundings. If the array of inputs suggests that the user is engaged in actions that require him to be alert (such as, driving a car), but his brainwaves and/or other signals suggest that the user is not fully alert or concentrated (e.g., if the pulse drops below a threshold value, or if the head position turns downwards or nodding), then the system may generate an alert such as: beeping, or vibration, or vocal alert via loudspeaker or earphone (e.g., “You are getting too sleepy, be careful, you should stop driving and refresh”). The system may generate an SMS alert that may immediately be sent to a third party predefined in the system's setup. For example, for a user having diabetes, an alert may be sent to a parent or spouse or relative, or to an emergency medical center with information about the user's state, GPS position and other relevant data.

Some implementations may utilize a brainwave-based user-behavior predictor 437, which may continuously learns (and adapt to) user's thoughts and actions. The system may continuously monitor or listen to the user (via brain EEG sensors or electrodes, and/or other array of sensors), and learns the correlation between the sensors' inputs and the user's actions or behavior. When blood pressure of the user increases, and EEG or brainwave activity have a particular pattern or structure, it may indicate that the user looks for a candy to eat or for a cup of coffee to consume. The system may learn to predict such actions, based on the user's brainwave patterns, enabling the system to warn, to suggest preemptive actions, or to auto-complete user's actions if or when they match previously-observed patterns of user's brain activity.

Optionally, the algorithm that finds such correlations between past and current brain activity, may also consider other inputs and correlate them as well. For example: the position of the user, the user's biometric info, the time of the day this activity happens (does he always get stressed when he is late to work). Then, the system may alert the user that he should get ready to go, a few minutes before it gets too late and stressful for the user).

For example, the system recorded the user brain activity together with the action that the user opened the candy drawer in the kitchen and ate few candies. Two days later, the sensors record a brain activity which the system recognizes as the human behavior or thoughts that correspond to “I crave candy”. In response, the system may tell the user where the candy is (“go to the kitchen, second drawer from the top, next to the sink”), or it may tell the user “you are on a diet, skip the candy”, or tell the user “you just ate candy one hour ago, I recorded that event, so skip the additional candy now”. Optionally, the user may tweak what the system recommends to him once his thought/behavior is identified.

Optionally, a record of all the times the user thought of eating something sweet, and/or actually took a candy and ate it, may be recorded as a log. The full log of this type of activity, or a summary log (e.g., “Monday: user wants candy at 06:00, at 09:35, and at 15:50”) may be stored for analysis by the user or a physician or a nutritionist (or other professional advisor). The learning of user's brain pattern may be an ongoing and virtually endless process. The more the system keeps recording the user's brain activity (and other activities from other sensors), the better the system may recognize when a pattern from one or more sensors is similar to a pattern from the past, and so the performance may continuously improve by the system as it “learns” the user and his pattern of behavior.

Some implementations may include a system with one-way connection or unidirectional connection; such as, systems where the user initiates an event or request or action using his brainwaves or thought. The system identifies the user's command by analyzing the sensed brainwave signals from the user's brain, and then executes the required command or action. Optionally, the system automatically recognizes specific brainwave pattern together with other inputs (such as GPS position, or heart rate, or body temperature, or surrounding noises and sounds) and based on the combined inputs it decides if a certain action is to be taken, with or without validation procedure. For example, a brainwave-related validation module 438 may be used to perform a validation procedure by speech, by tapping, by clicking, by re-thinking a particular thought, by thinking of a confirmation, or the like), in order to enable the user to validate or confirm a deduced command prior to executing such command.

Some implementations may utilize a brainwave-based distress-signal initiator module 439, to implement a feature of “Think to Signal S.O.S.”. When user is in distress or emergency, the user may think “S.O.S.” and the system may perform emergency action such as: “call 911” and/or send the GPS location and an SMS message of distress to a list of close friends or relatives, activate the microphone and/or camera to capture all video and/or audio, or the like.

For example, during the training/learning phase, the user may teach the system to identify when the user thinks of an SOS situation, and/or the system may identify, based on the user's brain waves, that the user is in distress and needs help. After the training/learning phase, the system continuously reads the user's brain signals. If and when a pattern of brain activity that correlated with the learned SOS mode, or if the system identifies irregular brain activity implying distress or disorder in brain activity, the system activates a chain of operations to handle the SOS situation. For example: “Call my spouse, then activate the SOS call center, sending my current GPS position as part of the alert”. Any set of actions may be pre-coded to the system to perform in case of “Think SOS” situation. The system may help the user in emergency, without the need to physically push a button (or any other physical action) and also without the need to talk to the system, which the user may or may not be able to do in some distress situations. It is possible to implement a “verification action” which means that if the system thinks it recognized SOS situation, the system may ask the user, via an earphone or speaker or displaying a message or vibrating or other signal, “Do you want to activate the SOS mode?” and may continue with the pre-planned SOS actions only if user confirms the actions. Verification may avoid false activation of SOS mode; but it may require the user to answer in a critical situation when he may not talk or even think properly.

Some implementations may utilize a “Think to Call” module 440, which may recognize when the user speaks and/or thinks about a person; and if this person is in the contact list of the user's device, then the system suggest to the user to call that person, with or without validation procedure. For example, Adam may carry an electronic communication device (smartphone, tablet, laptop); and the system may record brain activity of Adam (via that device, and/or via head sensors or electrodes or headset of helmet). The system may identify that Adam is thinking about Eve, for example, based on a previous pre-recorded training session in which Adam trained the system to recognize a brain activity pattern that corresponds to Adam thinking of Eve. The system continuously monitors the brain activity of Adam; compares the brain activity in real time to pre-recorded or pre-trained patterns; and if it identifies that Adam is thinking about a person whose name appears in a contact list of Adam (on his smartphone/tablet/laptop, or in Adam's social network), then the system initiates a communication session between Adam and that person (e.g., phone call, new text message, video conference), either automatically or subject to user approval (validation).

The system may be configured to adjust to multiple iterations; for example, if Adam thinks about Eve five times in one hour, then, only the first thought may trigger a communication session, and subsequent thoughts (within the hour) may be discarded. In some embodiments, the communication session may be activated only if the user thinks a “positive thought” about Eve, such as, that Adam misses Eve, or that Adam likes Eve; and in contrast, a communication session may not be initiated if the system recognizes that Adam is thinking a “negative thought” about Eve (e.g., anger or hatred).

Some implementations may utilize a “Think to Hang-up” module 441; when the user thinks of a pre-determined code (e.g., code-word, password, pre-defined term or word), the system recognizes this and takes the action of hanging-up (terminating, ending) an ongoing phone call. There may be a setting/learning phase where the system learns to identify the user's special code. After that, if the user's brain pattern correlated well with the pattern of the code, the system may take the action of hanging up the call. The recognition of the user's command need only be active while the user is on a phone call. At all other times, this feature may be dormant, thus saving power consumption and processing power. Whenever a call is initiated by the user, or received, the mechanism switches from dormant to active mode. Upon the termination of the call (via thought, or in a regular way), this feature may become dormant again.

Some implementations may utilize a “Think to Communicate Textually” module 442, allowing the system to act based on brainwave activity analysis and to send out SMS or Text message or email, optionally with a pre-defined set of properties. Upon installation or first use, or at any later time, the user may teach the system two different modes of his brain activity. For example, the system may record user's brain activity while user thinks of “Honey I am running late” and store it as “Action 1”; and then the system may record user's brain activity while the user thinks “I am hungry” and keep it as “Action 2”, and so forth. These patterns are stored in the system's memory, in an internal memory, or in an external device, or the cloud. The system may have access to this data when it needs to take actions.

The user may alter “Action 1” and/or “Action 2” at any time; such as, the user may decide that instead of thinking of “Honey I am running late” as Action 1, he wants to think of “Call Dad” as a new Action 1. To alter the commands, the user may re-enter teach mode or training mode, and may update the commands in the procedure explained above. After recording a pattern as “Action 1”, the user may be asked to repeat it, and he may then think again of the same action and let the system record its brain activity again. This way, the system may capture and store several patterns of the same word or action, that may enable the system to recognize when the user thinks “Call Dad” again.

After the training mode is completed, and the patterns are saved, and the system may track the user's brain activity and compare it with the predefined patterns saved. When the system recognizes brain activity similar to the pattern of “Action 1”, it may activate the operation assigned by the user to this command; such as, “Send to my wife an SMS saying, Honey, I am running late”. If the system recognizes brain activity similar to the pattern of “Action 2”, it may activate a different chain of actions; for example: “send an SMS to my son David asking if he finished his homework, and also, call Joseph on the phone and activate the speaker so I may talk with him”. This procedure may also contain a verification or validation process; after the system recognized that the user requests “Action 1” based on user brain activity, the system may ask the user “Do you want to send an SMS message indicating that you are late?”, and may execute the action only if the user confirms “yes” (by tapping, by thinking “yes”, by re-thinking “Honey I am running late”, by thinking “I confirm”, by saying “yes” or “I confirm”, or the like).

In another example, while driving home, the user feels hungry. He then thinks “I am hungry” which is a pre-defined thought that the system knows to identify as described above. The system recognizes this thought, and initiates a set of pre-defined actions that were assigned to this thought in the settings of the system; for example, “Send SMS to spouse, requesting to heat-up dinner” or “Send SMS to spouse, inviting spouse to go out to restaurant”.

Some implementations may utilize a “Think to Accept/Reject an incoming call” module 443. The user hears or sees who is calling (an incoming call), and may think to select whether to answer this call or not, and optionally whether to send back to the caller a text message (SMS, email, Text message, MMS, or the like) with pre-defined text (e.g., “I am busy right now, I may call you later”). Upon setup, in a training session, the system learns two distinct brain patterns of the user, and keeps them recorded. One means “Answer an incoming call”, and the other means “Reject an incoming call” (or, “Reject and incoming call and send back an SMS message indicating that I am busy and may call back later”). While teaching the system, the user may concentrate on two different ideas or visualizations or words, to allow the system to learn two distinct brain patterns. These do not have to be the textual descriptions shown above, but rather, may be any suitable image or idea or feeling or word that may allow the system to store the brain signals associated with it in a way that may later be used to identify if the user thought of the first type or the second type of thought. This feature remains dormant until the phone rings, to reduce power consumption and/or processing power, and optionally, to allow re-use of the same code in other context if desired.

When an incoming call enters, the dormant procedure is evoked, and it tests how the user's current brain activity signals correlate with the two predefined modes. If user's brain activity correlates with the first setup mode, the system understands that the user wants to answer this call, and it may take the action of receiving the incoming call and let the user have this call. If the other predefined mode is recognized as the user's brain activity now, the system understands that the user does not wish to answer the call; it may then refuse the call, and may also send the other party an SMS, or other similar message, saying: “I am busy right now, I may call you later”. This allows the user to make a decision regarding the incoming call with his thought only. The process may be used with, or without, a verification step to verify that the user meant the action as it was perceived by the system.

Some implementations may utilize a “Think to Increase/Decrease Volume” module 444, allowing a user to utilize thought in order to modify a volume level of his electronic device which may be playing an audio clip or a video clip. For example, upon installation or first use, or at any later time, the user may teach or train the system two different modes of his brain activity. For example: The system may record user's brain activity while user thinks of “Increase Volume” and keep it as “Action 1”, and then the system may record user's brain activity while user thinks of “Reduce Volume” and keep it as “Action 2”. These patterns may be kept in the systems memory, the immediate internal memory, or external device, or the cloud. The system may have access to this data whenever it needs to take actions. User may alter “Action 1” or “Action 2” at any time; the user may decide that instead of thinking of “Increase Volume” as Action 1, he wants to think of “Louder” as Action 1. The user may then reset the system in training mode and update the commands in the procedure explained above. After recording a pattern as “Action 1”, the user may be asked to repeat it, and he may then think again of the same word (e.g., “Louder”) and let the system record his brain activity again. This way, the system may keep several patterns of the same word that may enable it to recognize when the user thinks “Louder”.

After the teaching is completed, and the patterns are saved, the system may exit the setup and start tracking the user's brain activity and compare it with the two predefined patterns that were saved. If the system recognizes brain activity similar to the pattern of “Action 1”, it may activate the operation “turn the volume one step higher”. If the system recognizes brain activity similar to the pattern of “Action 2”, it may activate the operation “turn the volume one step lower”. This process may also contain a verification procedure; after the system recognized that the user requests Action 1 based on user brain activity, the system may ask the user “Do you want to turn the volume one step higher?” and may execute the action only if user confirms “yes”. In other embodiments of the invention, the user may train the system to recognize a thought of “mute the volume”, a thought of “increase volume to maximum”, or other suitable commands.

Some implementations may utilize a “Think to Modify Screen Brightness” module 445, allowing the user to utilize thought in order to increase or decrease brightness level of a screen of the electronic device. For example, upon setup the system learns two distinct brain patterns of the user, and keeps them recorded. One means “More”, and the other means “Less” (while teaching the system, the user should concentrate on two different ideas or visualizations or words, to allow the system learn two distinct brain patterns of him). Later, whenever the system recognizes one of these patterns, the system may determine that the user wants to modify screen brightness upward or downward, and may perform this action immediately upon such thought detection (e.g., without a validation procedure). This feature may be enabled at any point of time; or it may be enabled only if the user is in the “set screen options”, such that at other times this feature may remain dormant and the system may not try to correlate the user's brain activity to these two commands (thereby reducing power consumption, reducing processing efforts, and allowing re-use of the code in other context if desired).

Some implementations may utilize a brainwave-based Flight Mode toggling module 446, or a brainwave-based Airplane Mode switching module, in order to allow a user to utilize thought to toggle or switch-on or switch-off a Flight Mode or Airplane Mode of the electronic device (e.g., a mode in which all or most wireless transceivers of the device are disabled). For example, upon setup the system learns two distinct brain patterns of the user, and keeps them recorded. One means “On”, and the other means “Off” (while teaching the system, the user should concentrate on two different ideas or visualizations or words, to allow the system learn two distinct brain patterns by him. Later, when the system recognizes one of these patterns, it knows the user wants to turn flight mode on or off, and may perform this action immediately. This feature may be enabled at any point of time; of it may be enabled only if the user is in the “set flight mode options”, and at all other times this feature may remain dormant and the system may not try to correlate the user's brain activity to these two commands thus freeing battery power, CPU power, and allowing the use of the code in other context if desired. In some embodiments, the smartphone may identify automatically, from the Calendar or Schedule application, that the user is about to take a flight at 11:00 AM, and in the time frame of 10:00 AM until 11:30 AM may automatically activate the searching for this thought-pattern.

Similarly, some implementations may utilize a “Think to Toggle” module 447, in order to allow a user to utilize thought in for toggling between two possible states or modes or values of a parameter or a property of the electronic device, or to toggle a dual-state or a binary parameter of the device; such as, activate or deactivate Wi-Fi; activate or deactivate BlueTooth; activate or deactivate GPS; enable or disable Internet connection; suggest or do not suggest wireless networks available to connect; activate or deactivate personal wireless Access Point (AP) or Wi-Fi hot-spot; turn-on or turn-off location services or location-based services; choose operator automatically or manually; mute or un-mute audio; turn-on or turn-off Silent Mode; turn-on or turn-off Vibrating Mode; or the like.

Similarly, a “Think to Browse or Scroll a List” module 448 may utilize user thought to allow a user to select an item from a closed list of three-or-more items (e.g., ringtone selection), by allowing the user to think “go up on the list” or “go down on the list” and subsequently to think “select the current item on the list”. The system may be used as an interface to switch on and off (or any other change of settings) different functions of the device.

The system may convert brainwave readings into meaningful data, such as objects, thoughts, and cognitive commands. The system may scan this data and may search for thoughts that are related to the device functionality. Once the user is thinking of a smartphone related action, which may be executed by changing the state of the setting (e.g., turn vibration off), the system may execute it. This feature may also use the validation feature (by clicking, by tapping, by re-thinking the command, by thinking of a confirmation message, by verbal confirmation, or the like) to make sure the user intentions were fully or correctly understood from the brainwaves readings.

In some embodiments, the user may firstly think of the feature (e.g., silent mode) and may then think of the status (e.g., on or off) or parameter (volume level on the scale of 1 to 5). In alternate embodiments, the user may think of the outcome of the operation (e.g., phone vibrating). The setting's parameter may be binary (e.g., on/off), discrete (e.g., volume level on a scale of 1 to 5), a data value (e.g., the name of a wireless network to join), or in other suitable format. Optionally, the system may firstly decipher the user's intentions to join a network (e.g., the user thinks of “Wi-Fi” or of an image of a wireless router), and then the system may use any means of output (such as audio output or text) to inform the user that the system understand his intention to change some settings and prompt the user to think about the requested setting's parameter value.

Parameters may be explicit (such as a number), or may be of a thought paired with the requested outcome in the training process, e.g., while training the system the user was asked to think of something that may be paired with the function of turning off the vibration, and whenever the user thinks on that thing afterwards the system may translate the brain signals into “turn-off vibration” command to be executed by the device.

Some implementations may utilize a “Think to Dictate” module 449, allowing the user to dictate a text (e.g., an email message, an SMS message, an Instant Messaging (IM) message) by thinking the message. The user thinks of the text message, and by recognizing his thoughts only, the device autonomously writes (composes) the message, including the contacts being filled-out automatically in the “to” field, the “cc” field, or the like. For example, when this mode is turned on, the user thinks of a message, word by word, and the system recognizes each word or each sentence and writes it as a text in a text message or email or IM message, or as a word processing document. The system determines what the user is thinking about because it keeps track of user's brain signals at previous times (e.g., the system may always receive and store user's brain signals; but the system may also do so only at times the user activates the system). When the user is writing a text, the system may correlate and tag the brain activity at each time segment, with the actual text that the user typed at that same time. This tagging and correlation procedure teaches the system of more and more words, whole phrases, sentences, and ideas that the user writes, and how his brain activity is recorded for each of them. This way, when the user wishes to dictate a text by thinking the message, he turns the dictation mode on, and the system continuously receives current user's brain activity, and looks for correlation(s) with the bank of stored and tagged data it accumulated so far. Whenever a current brain activity is matched with stored and tagged brain activity of the user, the tagging of the stored info is used as the text that the user is now thinking of, and it is added to the text message that is under dictation (being composed). The longer the system accumulated data from the user, the more versatile and robust it may be in recognizing the different signals from the user's brain and what text is related to them.

Some implementations may utilize a “Think to Record” module 450, allowing the user to activate or deactivate a microphone and/or a camera of the electronic device, by using thought. This feature may be implemented similarly to the features described above, of differentiating or discriminating between two thoughts based on pre-trained brainwave activity, similar to the “Think to Toggle” mechanisms described above.

Some implementations may utilize a “Think to Read Next Message” module 451, allowing the user to utilize thought in order to command the electronic device to present the next message relative to a current message (e.g., text, SMS, IM, email) being presented. In a training phase, the user may think of a “code” representing this action. It is noted that in this implementations, as well as in other embodiments, the system may utilize an algorithm for identifying a sequence of events (or readings, or patterns) in the EEG, or other input from the user, and may also determine a few “codes” that may trigger the desired action. For example, the system may record brainwaves of the user thinking of “Next” several times, and then the algorithm may operate such that any brainwave pattern or signal which may be sufficiently-similar (e.g., based on a proximity metric or a threshold value) to any one of these “Next” brainwave representations, should trigger the desired action. In other embodiments, the system may learn such “codes” on-the-fly, and without necessarily using a formal or initial training phase; such as, the user may start using the system, not specifically in training mode, and the system may gradually learn, automatically, which brainwave signals the system is able to detect and capture every time that the user “skips” or “jumps” or “advances” to the next message (e.g., by also monitoring monitor when the user make such a “jump” or “skip” manually on his electronic device); and after few times, the system may learn which EEG (or other) signals or brainwave signal(s) are generated immediately prior to browsing to the next message; and the system may subsequently utilize such identified signals, or suggest to the user to utilize tem and to act on them, from that point in time and onward.

For example, in a formal training stage, the user may be imagining mail envelope, or thinking of the phrase “Next message” or “next” or any other unique pattern of thought the user concentrates on. In this learning phase, the system may register the User's brain signal pattern during the learning, and store it as the reference signal to operate this feature. This learning may be done once, or by repetitive thinking of the same code; and the system may register a set of brain signals as the reference code. The user may return to the learning mode at any time and reset the “code” to a new one.

When the user wants to activate this feature, for example, after seeing that car traffic is too slow, or after last-minute issue is preventing from leaving the office in time for a meeting, the user may just think of the “code” and the system may recognize that the current brain activity correlates with the code brain activity. At this point, the system may jump to the next email/SMS/MMS/Text message in the user's inbox or any other container of messages being browsed. This feature may be activated with or without verification before action. When verification is needed, the system may whisper to the user “Are you sure you want to move to the next message?” and may activate this feature only if the user gives positive answer to the verification (verbally, or by tapping or clicking, or by a confirmation thought).

Some implementations may utilize a “Think to Read Next/Previous Message” module 452, allowing the user to utilize thought in order to command the electronic device to present the next or previous message relative to a current message (e.g., text, SMS, IM, email) being presented. In a training session, the system learns two distinct brain patterns of the user, and keeps them recorded. One means “Next”, and the other means “Previous” (while teaching or training the system, the user may concentrate on two different ideas or visualizations or words, to allow the system to learn two distinct brain patterns by him). At any later stage, whenever the system recognized one of these patterns, the system knows that the user wants to read the next or previous email/SMS/MMS/Text message, and may perform this action immediately. This feature may be enabled at any point of time, of it may be enabled only if the user is reading his mails and may remain dormant at any other time, e.g., the system may not try to correlate the user's brain activity to these two commands thus freeing battery power, CPU power and the use of the code in other context if desired.

Some implementations may utilize a “Think to Launch/Close an Application” module 453, allowing the user to utilize thought in order to command the electronic device to launch (or to terminate) a particular application, or a pre-defined set of multiple applications. The System recognizes when the user wishes to Open or Close one of the applications (“Apps”) on the device, and may perform this operation for him based on his thought only. The user may utilize this feature with a suitable device (e.g., smartphone or tablet), able to receive notifications of translation of brain signals into meaningful data such as (but not limited to) cognitive commands, free text, visual images, or the like. The system may detect a user's intention by thought, to open a specific “app”, and via the communication channel may open the application on the device.

The selection of the application to start may be pre-defined by the user, or may be done by: browsing between applications, choosing application without browsing, or other suitable ways. In the browsing scenario, the user may train the system to recognize different browsing commands (such as “up”, “down”, “next”, “previous”, or the like). During the usage, the user is presented with a list of applications in graphical or textual or audio-based manner (e.g., a grid of icons, a list of applications). The user may use commands to navigate through the different applications until the requested application is found or selected.

Alternatively, direct application invocation may be used. In this scenario, the system is trained to recognize the intention of the user to start a specific application by detecting patterns in brain signals. The training process may be active or passive. In an active process, the user trains the system to match between a pattern/mental command to a specific application (e.g., the user is asked to think “open calendar” and then this thought may be used later to trigger launch of the calendar application). Those mental commands may be to think of the application (e.g., think “clock” to open the clock application, or think “calendar” to open calendar), or may mean to think of the image icon (e.g., to think of the image icon itself and not the application).

In a passive process, the system extracts the thoughts used to open application from the user's thoughts while using the device. For example, it may log user's brain signals, and combine those with data from the device, and when the user is opening the calendar application, it may analyze the data prior to the user starting the calendar. Given more than one reading, it may be possible to find patterns that are shared by both reading and thus eventually find a pattern that is correlating to “open calendar” thought.

In some implementations, a specific mental command or thought may be used in order to trigger closure of the currently-open application that is currently shown on the device's screen.

Some implementations may utilize a “Think to Activate a Command in a Running Application” module 454, allowing the user to utilize thought in order to choose or activate a particular action to be performed in an application running on the electronic device. For example, the user may think of a command (e.g., from a closed set of commands) that may be executed by the application of the electronic device based on such user thought. The system may provide third-party developers the ability to operate or control their applications by the invention's ability to translate thoughts and brain activity into meaningful data and commands.

The invention may allow such third-party to define actions (e.g., “send”), and when the application is installed the user may train the system to detect those actions based on user thought. Once the user has trained the invention, it may be possible to operate the app using those actions based on sensed brainwave activity.

Another possibility is to use actions that are supported over all the applications that may be installed on the phone. For example, “Send” is an action that may be used in many applications (email, SMS, IM). Third-party developers who may use the application, may take advantage of such commands and by that they may add “Thought interface” support to their application for those specific commands. A developer may list in a configuration file all the commands their application supports, the commands that the system already knows how to recognize (e.g., because the user had trained the system to detect such commands for other purposes, e.g., for the purposes of a different app), may work automatically once the app is installed. For all the other commands, the application may inform the user that once the invention is trained (using the invention training interface) to recognize those commands, the user may use them with the newly installed app. In other words, the user may train or teach the system once only the thought brain activity of “send”; and this may be used across multiple applications that may utilize a “send” command.

Some implementations may utilize a “Think to Edit Meetings” module 455, allowing a user to utilize thought to set or edit or delete a meeting in a calendar (or scheduling) application. The system may be used as an interface for a calendar application (on a smartphone or other platform such as a personal computer), or as a direct interface to the user's calendar data. After training the invention to recognize the relevant commands needed for interfacing with the calendar (such as “meeting”, “set”, “invite”), the user may use the system as an interface to the calendar.

While using the system to manage the calendar, the user may directly manipulate data (e.g., think “add a meeting with John on Tuesday at 10 AM”), or use the system to feed data step by step. For example, the user may think about a “new meeting” or alternatively the “calendar app” or any other thought that the system is trained to match with this functionality. Then the system may ask the user to choose (by thinking, or by other interface, or by a mixture, e.g., the user thinks of a meeting and clicks on a button on the screen and then continues to input parameters using thoughts) an action (e.g., set, edit, delete). Once the user chose an action (by thought or by any other interface), the system asks for the other needed parameters (such as day, invitees, subject). The thought-based interface may be used as the only interface, or combined with other interfaces (e.g., the user thinks “calendar” and then clicks on the button “add meeting”).

The invention may use data from the user's usage to make the process possible even if the user didn't train the system to detect all the needed thoughts. For example, if the user did not train the system to detect all the actions needed to manipulate the calendar, the system may use any output mechanism (such as screen, or earphones), to help the user choose the needed actions. For example, it may write “you may add or delete meetings. Please think 1 to add a meeting and 2 to delete a meeting”.

Another way the invention may support incomplete training is by using existing data from the user's calendar. If, for example, the system was not trained to detect thoughts related to different contacts (and therefore the user may not think of the person he wants to schedule a meeting with), the system may list contacts it believes the user may want to schedule a meeting with (based on data analytics such as history of previous meetings, phone calls, emails contextual analysis), and let the user choose based on index (e.g., “For scheduling with John think 1, for Adam think 2”), or by listing them one by one (e.g., “if you want to schedule with John think OK, otherwise think cancel”). Optionally, this process may utilize a user-validation or user-confirmation procedure, to reduce or minimize implementation errors.

Some embodiments may similarly utilize a “Think to Edit Alarm Clock Events” module 456; since alarms maybe similar to meetings in nature (having a due date, due time, and may be repeatable) and are in fact simpler data objects (do not have a location, invitees); and therefore this feature may use the same or similar abilities from the meeting or calendar feature described above, in order to allow a user to utilize thought for creating, editing and/or deleting alarm clock events.

Some implementations may use a “Find-Me by Thought” module 457; for example, the user does not remember where the device is, he may think of the “Find Me” code, and upon recognizing this, the device may make a sound or may send an email with GPS location, to help locate its position. In a preliminary setup phase, the systems learns a special “code” to be used by the user whenever he wants to find or locate the device. The code is learned by storing the brain activity of the user while thinking on this unique code. For example, the user may visualize the device, or think of the words “Find Me” or get stressful intentionally, or think of an image of binoculars pointed at a smartphone. The system may record the brain activity during this code-establishing phase, and saves it. After this setting mode, whenever the system may identify that the user brain pattern matches (or closely correlates with) the predefined “code”, the system may recognize that the user wants to find the device and may take predefined action(s), such as, triggering the phone to beep or sound an audio signal, or send email message with its position or any other means to convey its location to the user. In some embodiments, the system may recognize that the user is thinking “find my smartphone”, and in such case, the system may send the smartphone location (e.g., the smartphone was forgotten at the local coffee-shop) to a destination other than the smartphone itself (such as, to the smartphone of the spouse of the user; to the home phone of the user which may be capable of texting/messaging; to a fax machine of the user; or the like).

Some implementations may use a “Password by Thought” module 458. For example, the user may provide a password to any system or website or application, by thinking on a pre-determined password (no key presses, no sound used; password is recognized from user's thoughts only). In a “set password” mode, the systems asks the user to think of something that may be his password. It then records the brain waves generated by the user while thinking of the password. This may be done a few times to better register the brain waves signatures of the user. After this “set password” mode, whenever the user wishes to enter the password protected page, account, data, email, computer, social network, electronic device, website, web-mail, bank account, or the like, the systems requires that he think of that password, and takes record of the user's brain waves. By comparing the pre-recorded brain waves with the current brain waves, the system may authorize or un-authorize the user's access based on the brain waves generated while thinking of the password.

For example: The user opens a new email account on Gmail; the email system asks him to create a new password by Thinking about a six-words sentence (“the purple bird eats hot beans”); the system records the brain activity for this thought. The next day, the user logs in; the system asks him to Think of his password; the system captures and compares user's brain activity with the password stored brain activity; and authorizes, or denies, access to the email account accordingly.

In another example, when creating a PayPal account, the site presents the user with a list of pictures and asks the user to pick one and think of it. PayPal keeps record of the picture chosen and the brain activity recorded during this time. When, at future time, the user wishes to use his PayPal account, the site asks the user to “pick” the right picture just by thinking about it, without clicking or tapping. Only if the user picked (by thought) the same picture as in the password setting phase when he created the account, and also, the brain activity now matches that when the password was set, PayPal may allow using the money in the account.

With some variation to this last example: whenever the user asks to access his PayPal account, PayPal may present to the user the picture he chose originally, and compares the brain activity of the user now with that when the user created the password; and only if they match, then access is allowed.

Some implementations may utilize a “Think to Perform On-Screen Gestures” module 459, allowing the user to use thought for performing one or more touch-screen gestures, e.g., zoom-in, zoom-out, scroll down, scroll up, swipe right, swipe left, swipe up, swipe down, or the like; or a set of six or eight gestures. For example, in a preliminary setup phase, the system learns to identify six different brain waves pattern for six different thinking patterns by the user. Each step, the system asks the user to concentrate on a specific thought, and registers the brain waves associated with it. At the end of the setup mode, the system may be able to identify when the user brainwaves correlate with one of the above six pre-learned patterns.

In daily operation, whenever one of the six preset brain waves is identified, the system may execute a command associated with it. The commands may be context-related and may depend on the exact state of the system. For example, after commands 1-6 are being setup, if the smartphone is off, and user thinks of “command 1”, then the system may turn the smartphone on. At this new state, if user thinks “command 1”, the system may step one application to the right (e.g., the application icon to the right of the currently highlighted application icon may become highlighted). If user thinks “command 2”, the system may move one application to the left. Thinking “command 3” may, for example, open the currently highlighted application.

Once inside an application, the 6 different commands may perform different actions inside the application. For example: Once inside the email application, Command 1 may now mean “open the current email”, Command 2 may translate to “read the next email”, Command 3 may translate to “delete current email” (in which case, a validation procedure may be run before the actual deletion of the email; Command 4 may be translated to “Archive this email”, and Command 5 to call the sender by phone; Command 6 may mean, exit this application (and return to the main screen of the smartphone). Other suitable actions may be triggered by thought.

Some implementations may use an “autonomous unlock if the user becomes alert” module 460. If the user becomes alert, then the device performs auto-unlock (with or without validation question: Do you want to unlock?), or a similar operation which “wakes up” the device or takes the device out of sleep mode/stand-by mode/reduced-power mode/reduced-functionality mode/hibernation mode. The invention may be used to activate or unlock a device if the user wants it (via a thought) to be activated or unlocked. This issue becomes more relevant when the screen used is interfering with the user vision (e.g., head mounted display or retinal display). The invention may be used to decide when the user wants to display a device's user interface (e.g. to open and unlock his smartphone or to wake up a device that uses screen that interfere with the users vision, such as head mounted or retinal display).

The invention may be used in combination with head mounted displays or virtual retinal display. Such displays interfere with the normal vision of the user. The invention may be used to determine if the user wants the display to be visible or invisible (either by not displaying anything if it may be transparent, or by not adding any layer of information if the display is showing information as man-in-the-middle). The invention may be used to learn and find patterns that are correlated with user becoming alerted before he even know he wants to use his device.

Some implementations may utilize a “fade-out audio upon detection of sleepy user” module 461. For example, if the user is becoming sleepy, the device recognizes and fades out the music being played by the device, e.g., from an audio-player application of the smartphone or tablet. Using brain waves readings, face muscle activity measurement and other types of sensors, the algorithms may estimate the user's alertness level, engagement level, or the like; and may be able to take action or recommend action accordingly. Therefore, the system may detect when the user is becoming sleepy or not engaged with the device and automatically make it invisible or non-disturbing for the user. For example, if the system is used in combination with an audio system, and the user was listening to music but became sleepy, the invention may reduce the volume gradually as the user falls asleep. The system may also detect when the user is not concentrated on the device, and lock it or pause tasks that assume that the user is interacting with the device (e.g., games or applications that measure usage time).

In some embodiments, the device may utilize a “closed set of most-common commands” module 462, to learn a closed set of items or commands upon device setup. Upon a first usage of a device (smartphone/tablet), the device asks the user to Train it to perform a pre-defined list (a closed list) of particular thought patterns, such as: lock; unlock; next song; shuffle songs; unlock and open texting application to show me incoming text; unlock and open email application to show me incoming mail. Optionally, only a pre-defined list of six (or other number of) predefined tasks, that “every” new user may train. Then, these thought-patterns may be part of the user interface of the device.

In the system setup mode, the system learns to identify 6 different brain waves pattern for 6 different thinking patterns by the user. Each step, the system asks the user to concentrate on a specific thought, and registers the brain waves associated with it. At the end of the setup mode, the system may be able to identify when the user brain waves correlates with one of the above 6 pre-learned patterns. In daily operation, whenever one of the 6 preset brain waves is identified, the system may execute a command associated with it. The commands may be fixed and predefined in the setup mode. For example: The 6 commands may be programmed to perform: lock; unlock; next song; shuffle songs; unlock and open texting application to show me incoming text; unlock and open email application to show me incoming mail.

Whenever the system identifies one of these commands based on the current user brainwave activity, it may perform the appropriate command. The predefined actions may also be setup to a default list that is factory-determined and may not be altered during the use of the user; or it may be altered by the user (e.g., to include other and/or alternate and/or additional thought-patterns, for example, “open the camera application”) and, at any subsequent point of time, may be restored to the default factory settings.

In some implementations, the device may assign a set or batch of operations to a single thought pattern, by utilizing a “Think to Perform a Batch of Commands” module 463. The device has a general ability to allow the user to train the device to recognize a thought pattern, and to identify it as a Chain of one or more Commands and/or Parameters (variables); using a GUI or UI, optionally with a “scripting language” or “action scripts”. For example, the user may use his finger to tell the phone to record a thought pattern; and then, may use the GUI to tell the phone, that this thought pattern should correspond to: “Unlock my phone, call my voice mail, wait 5 seconds, enter 5678 as my password, wait 3 seconds, and enter 1 to hear new messages, and switch to Speakerphone”. This may allow the system to implement a “macro” feature, in which a single thought causes the system to perform a list-of-actions (and not only a single action) that were pre-defined, such that the sequence of operations is triggered by a single thought. This may be done by aliasing of a list of actions to a single trigger. It allows a user to perform complicated and multi-steps tasks based on reading of his brain waves and identifying that current brain waves represent the chain of actions of predefined set 1 or set 2, or the like.

Some implementations may utilize a brainwave-based “Running Late” message generator 464, triggered by a use thought. User may think to activate a sending of a “Sorry, I'm late to the meeting” message, and the device may identify the next meeting in the user's schedule, for example from the Calendar application (a local Calendar application on the smartphone, or a cloud-based Calendar application), and inform the participants that the user is going to be late (by SMS or an audio message conveyed telephonically, or any other means)

In the setting or learning phase, the user may think of a “code” representing this action. This may be imagining getting late, or thinking of the phrase “I'm late” or any other unique pattern of thought the user concentrates on. In this learning phase, the system may register the User's brain signal pattern during the learning and store it as the signal to operate this feature. This learning may be done once, or by repetitive thinking of the same code and the system resisters a set of brain signals as a code. The user may return to the setting/learning mode at any time and reset the “code” to a new one.

When the user wants to activate this feature, for example, after seeing that the traffic is too slow, or after last-minute issue is preventing from leaving the office in time for a meeting, the user may just think of the “code” and the system may recognize that the current brain activity correlates with the code brain activity. At this point, the system may automatically look into today's meetings at user's calendar, find the next meeting scheduled. If meeting has also a list of (one or more) participants, the system may generate an SMS/Text/email or other message to each participant saying: “I'm sorry, I am going to be late to the meeting” (the exact text may be defined by the user in the settings of this feature. If the system also sees that the user use, for example, Waze to navigate to the meeting place, it may use the Estimated time of arrival (ETA) to the destination, and include in the message also an estimated delay time, for example: “Sorry, it seems I am going to be late by 15 minutes to our meeting at [info from the calendar]”. This feature may be activated with or without verification before action. When verification is needed, the system may whisper to the user “Are you sure you want to send Sorry I'm late message to all participants of the 15:30 meeting?” and may activate this feature only if the user gives positive answer to the verification.

Optionally, the above-mentioned feature of initiating a “Sorry I am late” message, may also be implemented as an active process that may initiate a question to the user saying: “it seems to the system that you are going to be late by 15 minutes to your next meeting—Do you want me to automatically inform the other participants?” and the user may think Yes/No as a response, in order to command the device (by thought) to inform, or not inform the recipient(s).

Some embodiments may use a brainwave-based emotion-oriented communication augmenting module 465, in order to tracks user's emotions and add a sign or icon or avatar or other expression that matches this mood in user's chat or Internet game or SMS text or email; thereby automatically augmenting the user's experience, and/or the reading experience of third parties.

Sometimes, when reading text written by somebody else, the true intentions of the writer are lost. Since others cannot see the writer nor hear his voice tone, it may become difficult to get his feelings and intentions. The invention may be used as a supplement for text composing or reading, and may provide users with the emotional feeling the writer was trying to express.

When writing the text, the invention may monitor the writer's feelings. Feelings may be extracted from brainwaves or face muscles (e.g., if the writer is smiling while writing, or is crying). The invention may then add textual or graphical supplements to the text to emphasize the author's feelings. Such supplements may be emoticons, avatars, text remarks, or the like.

When both the writer and the reader of the text use the invention, the system may signal the reader when he misinterprets the writer's intentions. For example, the system may monitor in real time the recipients feelings while reading the text and if the user shows a different emotion than the writer was expressing (e.g., if the writer was happy when writing an SMS to the recipient, and the recipient misunderstood the writer's emotions and as a result becomes sad) the system may notify the user that there is a misunderstanding or mismatched emotions.

The invention may also be used to provide an avatar expressing the feeling of the writer. In such case the invention may log the writer's feeling while writing the text. It may also log facial expressions (such as smiles, blinks). The data is then used to animate an avatar of the user. This avatar may be presented on other devices and may be updating as text appears on the screen of those devices.

Some implementations may use a “thought-based audio player” module 466, utilizing user thought in order to trigger movement to next or previous song. The system plays a song list, and upon a telepathic command by the user, the system jumps to “Next Song” or goes back to “previous song”. Upon setup the system learns two distinct brain patterns of the user, and keeps them recorded. One means “Next” and the other means “Previous” (while teaching the system, the user may concentrate on two different ideas/visualizations/words to allow the system learn two distinct brain patterns by him). After doing system setup, whenever the user plays songs with the Song Player application, the system keeps matching user's current brain signals with the two patterns of brain signals learned during the setup procedure. Whenever the system recognizes one of these patterns, it knows the user wants to move to the next or previous song in the playlist and may perform this action immediately.

In some implementations, a thought-based music generator module 467 may obtain and play a song based on a user thought. The system recognizes the name of a song that a user wishes to hear, and plays it automatically (with or without validation), based on a user thought. The user is Thinking about a name of a song, or a line from a song such as “I want your love”, the system recognizes this Thought as corresponding to Lady Gaga “Bad Romance” song; and obtains the song from a local memory unit or from the cloud/iTunes store and plays it, or, obtains a free audio sample of the song (from Amazon MP3 service) and plays it, or finds a corresponding music video of that song on YouTube and plays it. Optionally, the thought of the particular song may be identified, based on a pre-training session, or based on implicit learning (e.g., in the past, the user had a particular brainwave activity when he listened to that particular song on his smartphone, and that past interaction was captured and now matched). In some implementations, for example, the system may monitor the user's behavior and thoughts as well as the concurrent operations of the user's electronic device(s) (e.g., smartphone, tablet, television, radio); and the system may capture a particular brainwave signal or pattern, which the user thinks or emits when he is listening to the song “Counting Stars” on the radio; and the system may store such signals as reference signals; subsequently, if the system identifies the same (or sufficiently-similar) brainwave activity signal, the system may determine that the user is thinking of that particular song, and may proceed to, for example, (a) automatically find that song on YouTube or other streaming server and playback that song via streaming; or (b) automatically find that song, in digital format, in a local music repository of the user on an electronic device of the user, and playback that song to the user; or (c) automatically find that song, in digital format, in a cloud-based or remote music repository of the user, and playback that song to the user; or (d) automatically locate that song on an online music store, and purchase that song (by using the user's default or preferred or pre-defined billing method), and then download and/or play (e.g., streaming) that purchased song. All these may be performed without the user being required to say anything, or to say the name of the song, or to even think about the name or title or lyrics of the song (e.g., the user may think of the melody of the song but not necessarily about the song's name or lyrics; or vice versa, the user may think about the lyrics of the song and not its melody), or without requiring the user to “hum” or sing-aloud the song or its melody.

Some embodiments may utilize a “brainwave-based mood-oriented music player” module 468, to tracks a user's mood and play a song that suits the user's current mood. The system may continuously track the user's mood from his brainwaves signature. The more the system may be used, the more it may be able to correlate brain waves signatures to past signatures of the user and thus determine his mood, optionally asking the user to indicate what mood he now has (in a training session). When the system identifies a mood (for example: the user is sad, or happy, or anxious), it may set the music player to play a song list, or music channel, or a song, that suits the user's current mood.

One of few ways to implement this it that the system may play the same type of songs as the user chose to play in a past situation when his brain waves were of the same pattern as they are now. The system always tracks and records the songs/music channel/playlist currently heard by the user, and also tracks and records the user brain waves. So, at any moment, it may make correlations between current brain waves patterns and past patterns and so match a song/playlist/music channel that best fit it now. In another embodiment, the system may utilize a lookup table, which correlates a mood with a song or a playlist (such as, a “sad” mood correlated to sad songs or slow songs; a happy mood correlated to high-paced songs or pop songs).

In some embodiments, the system may utilize a brainwave-based advertising data generator 469, able to generate smart data for advertisers. The system may monitor user's behavior, attention, or the like, and may create meaningful (smart) data for interested parties, such as companies that advertise commercials on television or on the Internet. The smart data may indicate if the user notices the commercial or ignores it, was the user concentrated in the commercial or not, did the user remember the name of the published brand etc. and what was the user's reaction/emotion towards the commercial (liked, hated, was indifferent)

For example, in an advertising system, the invention may monitor user's behavior and/or attention via brainwaves and other sensors, and may combine data about the content that the user is consuming with brainwave readings and reading of the activities of the face muscles. It may extract meaningful insights about the user's feeling toward the content; for example if the user saw a commercial, what did the ad made him feel, if he remembers the name of the product couple of minutes afterward.

The invention may then send those insights back to the advertising system for optimization and statistics. Such optimization may be generalization of ways to attract this specific user (e.g., “this user is best shown ads which are comical rather than dramatic”), or may be used to tell for which types of product should the system target this user. Some other insights this system may provide for advertisers are: what type of products should be advertised to this specific user; what type of ads makes the user feel more engaged; how fast does the user lose interest; how long does the effect of the ad last.

The system may also be used to optimize the advertising: show the ad only when the user is mood that suits the ad; do not show the ad more times than needed, but enough times for it to be effective (e.g., if the user recognizes the ad and remembers the name of the product then it is sufficient); optimize the products for those who interest the user.

In some implementations, the user may activate or deactivate this feature, where the benefit for the user is that: the ads he may be exposed to, may be more for his taste (more engaging, less disturbing); ads may not disturb the user at times that may cause him to get annoyed or unhappy.

The invention may be used with devices such as Google Glass and with technology of computer vision that may enable providing the same type of insights for real world (e.g., non-digital) commercials or ads, or for commercials consumed by devices that do not integrate with the system (e.g., old conventional television). It may be also used to test the effectiveness of subliminal advertising, or the effectiveness of “product placement” in a movie or a television show.

In some embodiments, a brainwave-based content-tailoring module 470 may cause television content or Internet content to adjust itself to user's emotions/thoughts/mood/reactions. For example, user may watch a TV show, and the character that he likes the most, may become more dominant in the story, based on analysis of the brainwave activity of the user. Similarly, user may imagine a particular turn of events in the movie, which then takes place due to sensing that thought. In some embodiments, a TV show may have two or more alternate endings or twists in the plot, and a suitable option may be automatically displayed to the user based on his thoughts, or, in contrast to his thoughts in order to surprise the user.

In some implementations, similarly, the system may choose the best TV program/movie to best fit the user's current mood, or, if desired, to contrast the user's mood (such as, if the user is now sad, then, intentionally play an episode of the user's favorite comedy show in order to cheer up the user).

In some embodiments, the system may use a brainwave-based appliance activator/deactivator module 471, to turn-on or turn-off a household appliance based on user thought; for example, television, radio, music player, air conditioner, lights, dish-washer, or the like, for example, by thinking of the command “On” or “Off”. In the learning or training phase, the user intentionally thinks of two different modes. For example: “Turn it off” and later “turn it off” (Can also think simply “on” and later “off”, as long as the system gets two different brain signal patterns to identify the two different commands from the user). The system registers these two brain signal patterns (it is possible to redo this learning more than once and let the system register a “Set” of “on” s and set of “off”s).

After the learning phase, when the system identifies that the brain signal pattern correlated to the “on” or “off” command, the system turns the device “on” or “off” accordingly. In case of more than one device to control (such as, TV and radio and Dish Washer), either the user teaches the system many sets of “on” and “off” (a pair for each different device), and this way the command to each device is uniquely identified; or alternatively, the “on”/“off” command may be operated on the last device used by the user. Optionally, there may be other mechanism (not by thought) to set the “currently active device”, and the thought may always turn the currently selected device “on” or “off”).

In another implementation, the user may enable/disable a device by thought or by remote thought; and the mechanism may allow the user to Enable or Disable the use of a device (such as, a gun or rifle) by thinking of “Enable” mode or “Disable” mode. During the learning or training mode, the system learns the brain signal pattern of the user while he thinks of “Enabling” and/or “Disabling” command. After the training is complete, whenever the system recognizes brain activity pattern that correlated with the “Enable” or “Disable” action, it may automatically lock or unlock the device. For example: if a gun is taken from a policeman, he may lock the gun and avoid any firing from it by thinking on the “Disable” command. The system's brain activity detectors on the policeman head may identify this command, and may send a signal to a control unit (such as a CPU unit) integrated into the gun that may lock it from firing by anyone. This may practically allow a policeman (or soldier) to control his weapons and avoid their usage by a hostile person, or by any other person but himself.

Similarly, a brainwave-based window opening/closing module 472 may be used, to trigger opening or closing of windows or shades or blinds or curtains, based on user thought analysis. A device opens or closes any of the windows, at home or in the car, by user thought analysis only. A sensor reads the brain activity of the user, and correlates it with a pre-defined command (in a training session) that indicates “open my window” or “close my window”, thereby sending a command to a window opening/closure mechanism to operate accordingly. In subsequent operation, the user's brainwave activity is captured and compared to the previously-captured reference signals, and a command is performed if a match is found.

Some embodiments may utilize a brainwave-based channel-changer 473, to change a channel of television or radio or music player, based on user thought analysis. The system may cause a TV or a radio to move to next/previous channel based on the user thinking “Next” or “Previous”, similar to as explained above with regard to song skipping mechanisms. Another mode of operation is to find the channel that best suit the user's current mood based on his brain waves patterns and their correlation with past brain waves patterns and the channels user chose at those times in the past to watch. In another embodiment, a TV channel may be chosen automatically in order to alter the sensed mood of the user; such as, if the user's mood is sensed to be a sad mood, then, automatically turn on the TV and switch to the Comedy channel in order to cheer up the user.

In some embodiments, the system may skip or jump to a next (or previous) present channel, based on user thought analysis. In other embodiments, a user may think of a name of a channel (e.g., “CNN” or “101.5 FM”), and the system may identify and skip to that channel (e.g., based on a pre-training session that defines the reference brainwave activity for those target channels).

In some embodiments, a brainwave-based car ignition module 474 may be used to turn on (or turn off) an ignition of a vehicle of the user, based on the user's thought analysis, and without requiring the use to turn a key or to push any button. To avoid unsafe situations (e.g., that the user may unintentionally stop the engine while on a highway) this feature may be operational only if a certain set of rules are matched. For example: The user may only turn the engine on/off if the car is in a complete rest (not moving), and/or only if the car is either at the user's home or work parking lot (or other pre-set places the user defined as familiar and as appropriate to set the engine on/off), and/or other suitable safety precautions.

Some embodiments may include a brainwave-based appliance controller 475, allowing to use thought for operating the controls of a television, a radio, an air conditioner, or other electric appliance. User may control a set of operations in each device or appliance that are pre-programmed and trained by the system (e.g., change temperature of air conditioning unit; change channel in television or radio). A training session may be used in order to train the system to recognize a user thought which corresponds to the relevant command, which may later be executed when the same thought is identified (with or without a confirmation stage).

Some embodiments may include a brainwave-based light dimmer module 476, allowing to control a light dimmer via thought. In a learning phase, the user intentionally thinks of two different modes. For example: “Turn dimmer up” and later “turn dimmer down” (Can also think of “up” and later “down”, as long as the system gets two different brain signal patterns to identify the two different commands from the user). The system registers these two brain signal patterns (it is possible to redo this learning more than once and let the system register a “Set” of “up”s and set of “down”s). After the learning phase, whenever the system identifies that the brain signal pattern correlated to the “up” or “down” command, the system turns the light dimmer “up” or “down” accordingly.

In some embodiments, a brainwave-based vehicular-application controller 477 may be used, to turn-on or turn-off a vehicular application (e.g., navigation or mapping application). In the learning phase, the user intentionally thinks of two different modes. For example: “Turn it off” and later “turn it off” (Can also think simply “on” and later “off”, as long as we get 2 different brain signal patterns to identify the two different commands from the user). The system registers these two brain signal patterns (it is possible to redo this learning more than once and let the system register a “Set” of “on”s and set of “off” s). After the learning phase, whenever the system identifies that the brain signal pattern correlated to the “on” or “off” command, the system turns the device “on” or “off” accordingly. Similarly, the module may be used to analyze brainwave activity in order to send a command to a running vehicular application, while driving (examples: ask a navigation application or a mapping application to locate the nearest ATM or the nearest gas station).

In some embodiments, a “Think to Turn the Page” module 478 may be used to allow a user to turn page(s), via thought, in a book or an electronic book, or in a musical notes booklet. When the user plays notes or music, he may think “pass to next page” or “return to previous page” and the device may do this action. Same process may be used while user reads a book (an electronic book or e-book, such as Amazon Kindle) and want to turn a page without moving his fingers, via thought.

Some devices split the content that they show to units that may be displayed on their screen. For example, e-book readers allow users to consume the text by browsing different pages. Mobile phones and PCs have photo album applications that allow the users to go through the photos while browsing to the next/previous photo. Such devices may be used with the invention to provide better user experience. The invention may be used by the user to trigger a content navigation command (e.g., the user may think to trigger cognitive command that will: turn to the next page; go to chapter 3, show the previous album). In such case, the user may train the system to detect specific commands that may be used by the user to perform specific actions with the device (e.g., the user may train the system to understand that a specific cognitive command means to move to the next page).

Another use scenario is automatically detecting via thought when the user wants to consume another part of the content without the user explicitly asking for that (e.g., the invention may detect that the user is tired from the photo, unhappy from the current song, or that he finished reading a page). In this case, the invention may be used at first to sample the user's brain readings while the user is using the device. Information from the device may be feed to the invention and the invention may use both the brain readings and the events from the device to try and find patterns that has meaning in the context of the device usage (e.g., pattern X was repeating itself only two seconds before the user turns page forward). After the system learns and is trained to detect the needed patterns, once a pattern is detected the system may trigger the proper action on the device.

Some embodiments may allow thought-based voting (or gambling), via a “Think to Vote” module 479. If the user wants to put a bet on a horse, or football team; or vote in a TV program for one of the participants (as in “America has talent” voting), by thinking only (with or without validation before taking action), then the thought would be recognized by the system, and the suitable action may be taken automatically.

For example, while watching a horse race (in a real arena, or via TV or other media), the user wants to place a bet on horse X to win the race. He does not want to make a call, or record the command using voice. So, the user thinks silently, “I want to bet Y dollars on [horse name] or [horse number]”. The system keeps track of the user's brain activity and also keeps track of the race itself and so knows which horses are running in the race. The system then identifies the sum of money that the user wants to bet on, and the horse name (or number) that the user thinks of, and automatically places a bet on this horse, in this sum, using electronic betting mechanism (such as: online betting on the race through an Internet site, in which the user already has an account). This may be done with or without validation before taking action.

Some embodiments may include Systems with Two Ways Connection. This category includes systems where the user initiates a request, and the system may then validate the request by asking via an earphone or similar device if the user asked for X, and only if the user approves, then the system executes the required/predicted action

For example, a conversation analyzer and advisor module 480 may analyze an ongoing Conversation and give advice to the user. Upon user request (“Analyze this talk” or “analyze this conversation”), the system may analyze the personality of the person you talk with and advise you how to talk/interact with him.

In some implementations, a brainwave-based yes/no validation module 481 may be used. Whenever a yes/no question or suggestion is generated by the system to the user to decide, the system may validate if the user wishes (or does not wish) to perform this action before carrying on. Example: “Do you wish to call John Smith?” or “Do you wish to send this SMS to Adam”, or the like. Interpreting user brain signals (EEG and others) into meaningful information (thoughts, mental commands) may sometimes fail, due to an implementation error or inaccuracy. The invention provides means to verify and for substantially minimizing false positive interpretations or otherwise incorrect interpretations or otherwise inaccurate interpretations, of a user's thoughts.

Given the invention's capability of translating brain waves readings into significant data, and the ability to deduce an action to be performed out of the data (e.g., the system may read EEG signals, and translate them into a cognitive action such as unlock the device; the translation may be done by matching patterns in the EEG signals or by other means), this feature may be used to validate whether the deduction of the action is correct. The invention has a way to convert brain signals into cognitive action or different form of data (e.g., free text dictated by thoughts), and it may use this capability to verify the validity of its brain-to-data translation. The process of validating the data may include: Converting the brain signals into meaningful data; Informing the user of the deducted meaningful data; waiting for user confirmation or correction (either wait for a period of time, or halt until accepted by the user); Informing the user of the data interpretation may be done by an output interface such as (but not limited to) speakers, by announcing in a speaker the command interpreted, or by screen via displaying on a screen or by any other output mechanism.

Once the user is informed, the system may wait for approval or may give the user time to disapprove the interoperation. Such confirmation or cancelation may be done by an abort/confirm user interface. Such interface may be implemented as a button (physical or virtual), voice command, or by a thought that means “I agree” or “I confirm” or “confirmed”. For such thought deduction, the system may use a regular thought (e.g., user thinks “Agree” or “confirmed”) or a designated control thought.

Designated control thoughts: not all brain signals may be interpreted at the same ease. Some brain signals may be easier to interpret. Such signals may be used as Control signals. Control signals may be used as verification signals (e.g., Yes/No or Agree/Cancel). In such use the use flow may be: User thinks of an action; System translates user's thoughts into concrete action; System informs the user of what is about to be done; User may confirm, or given time to cancel.

For example, the user thinks about a command to perform an action (e.g., “Call Jack”). The system may convert the brain signal into meaningful data, and may conclude that the user wish to call Jack. The system asks the user “Are you sure you wish to call Jack?”, and the user thinks “Yes I am sure” or “yes I confirm” or simply “confirmed”, and this thought would suffice as a confirmation.

Another confirmation flow is to ask the user to think again on the same command/thought/idea. For example, if the user thinks “Call Jack” then the invention may read the signals and may ask the user (using any suitable output mechanism, such as a displayed message or an audio message) to repeat his command. If the system may not identify signals that translate into “Call Jack” in the next 10 seconds, then it discards the interpretation of the “Call Jack” command.

Some embodiments may utilize a thought-based “Where Is” locator module 482. For example, the system recognizes that the user is are hungry, and suggests where a nearby restaurant is, optionally tailoring the recommendation of the restaurant to fit a particular food item that the user is thinking about (e.g., hamburger), or to fit a history of user's activity (e.g., recommend a nearby restaurant that the user visited in the past).

In the learning or training phase (which may be done intentionally as part of the system setup, or as a continuously evolving learning while the system operates with the user on a daily basis), the system learn the brain pattern of the user when he is hungry, or wants a drink, or tired. This may be a closed set of few predetermined situations which makes the identification of one of these states easier; or an open-list of countless moods of the user which is more challenging to identify them all, but with enough training, it may be done. After learning some patterns like this, whenever the system recognized such a pattern, it knows the user is now hungry, and may find a nearby restaurant and suggest the user how to get to it. If the system recognizes the user is tired, it may suggest to take a rest, stop driving (if user drives) and may also suggest/inform the user where he may stop to take a rest from the drive

Some embodiments may include an Augmented Reality (AR) layer creator 483, which may be at least partially brainwave-based. Based on user state or experience or actions, the system adds augmented reality layers. For example, while the user speaks with a salesperson, the whisperer component may suggest that the offer is too high or that the person is lying. As another example, the user may want to buy a car, the salesperson suggests a price, and the system may automatically look for a price for this car and whisper to the user if the offer is good or not.

Some embodiments may provide a brainwave-based time/date inquiry module 484. For example, the user may think “what's the time” or “what date is today”, and in response, whisperer (earphone) may say the time (or date) in the user's ear discretely, or the smartphone may display the time (or date) on the screen. For example, in a learning phase (e.g., after the application is downloaded from the virtual store and run for the first time), the system may ask the user to think of a “code” or “action” that means he wants to know what is the time. The system may record the user's brain activity during this learning process. This may be done once or more than once for more exact identification of the user's brain pattern when he wants to know the time (or the date).

After the initial learning phase, the system may store the pattern of brain signal user has when he wants to know the time. From this point on, whenever the user wishes to know the time, he only needs to think of the “code” (for example: think of an image the wall clock at his home, or other particular code from the learning phase). The system may identify that the user's current brain signal means he wants to know what is the time, and may whisper the current time in the user's ear or may display it to the user on an OHMD. Similarly, the date may be queries by thought, and provided by earphone or display.

Some embodiments may provide a brainwave-based person identification module 485, allowing a user to initiate, via thought, a process that assists the use to identify a nearby person. For example, the user may think “who am I talking with?”, and the whisperer may identify the person in front of the user (or at the phone right now) and may whisper his name to the user discretely; and the system may fetch relevant data on this person such as, recent social media writings or “tweets”, or the like.

For example, the system may identify, and inform the user, who is he talking with, using one or more of the following options. If the person is in the user's contact list, and if the user talked with him in the past, the system may know, based on the data it constantly store during user's activity, when the user talked with this person (e.g., when user dialed him or was called by this person) because the person's telephone number is identified via the contact list. Moreover, the system may also tag the conversation data, e.g., the actual voice of this person as recorded during past talks with him, and may tag it with this person's name. If the person that talks now has the same voice signature as this past identified person, then the system may tell the user who is this person, when they last talked over the phone, and fetch more data on him (e.g., from social media pages or websites).

Alternatively, a similar identification process may be done if the user met this person in the past and had a conversation with him face-to-face. In this case the system may also have voice print of this person, and if user had the system with camera operation with it, system may also recognize the person based on his face (face recognition), and provide the identification and other relevant data (such as: when the user last met her face-to-face; or what is new on her social media site; or what is the connection with this person based on info in LinkedIn, such as mutual acquaintance or mutual past employer).

Alternatively, while talking with this person in the past, a third party might have said “please meet Joe”, or a similar introduction line, then the system may now look for Joe in user's contact list, or friends on Facebook. Alternatively, if the third party permitted, the system may search his contact list on his smartphone or on his social media accounts. If a match is found, the system may inform the user about this user and may fetch relevant data on this user as explained above.

In some embodiments, the system may utilize an animal brainwave-reading module 486, to allow a user to improve communications with an animal, a non-human animal, a pet, a service animal, a police or army animal, an anti-terror unit animal, or the like; by telling the user, based on the pet brainwave activity, at which state-of-mind is the pet, e.g., anxious, happy, hungry, angry.

The system may be attached to the animal. It may continuously read and register the brain signals from the pet brain. The system may let the user know the classification of the animal's brain activity: such as, is it afraid now, is it anxious, or the like. The information may be presented to the user in one of various output options: A text on a screen (on Smartphone, PC, special screen for this purpose only), an audio alert to an earphone (“The Dog is anxious, I suggest you try to calm him down” or “Your cat is hungry”), or the like.

Furthermore, some other features of the present invention, which are described above or herein, may be adjusted or adapted to allow thought-reading or brainwave-activity monitoring of a pet or animal, and optionally, allowing a pet or animal to control devices by thoughts (e.g., to open/close a doghouse door via thought of the animal).

Some embodiments may allow Adaptive Two-Way Connection, by using systems that register sets of inputs (Audio signals from a microphone that records what the user hears). Then, these arrays of inputs are analyzed by the system to recognize patterns that repeats itself. If a pattern is found, the system may then suggest the user to perform the next expected action, if it recognizes the situation that usually is followed by this action. Example: If user usually leaves work at 6 pm, system may suggest when the time is 6 pm “It's time to leave work”. If user calls Mom every Saturday morning at 10 am, system may ask “Do you wish to call mom?” on Saturday at 10:00 am.

Some implementations may predict and/or auto-complete user actions. The system keeps learning the correlation between user's actions (calling someone on the phone, going to take a sandwich from the fridge) and his brain activity as seen and recorded by the brain sensors. By continuously and automatically learning these correlations, the system is able to recognize, at present time, pattern in user's brain activity, and may now suggest to complete the activity the user started (or is about to start, or it supposed to start but forgot) based on his past behavior

For example: while user sits watching TV, a feeling of thirst to a beer crosses the user's brain (and cause a specific pattern of brain activity, which is different from just relaxing or getting sleepy in front of the TV). The system records the brain activity, and may also record the actions by the user that follow this thought, such as, the user stands up, goes to the fridge, opens it, takes a can of beer and drinks it. As the system continuously and automatically records both the brain activity, and the user's actions, it may, after some learning, predict what the user is about to do, based on his brainwaves pattern. In this example, after sufficient times the user may think about the craving for a beer, the system may be able to tell, based on the user's brain signal, that he craves a beer, before the user even made his first move towards the fridge. If and when the system identifies the state of mind and correlates it to previous behaviors, the system may arrange that a cold beer would is served to the user while he remains sitting in front of the TV (e.g., by commanding an automated robot or machinery for serving drinks); or the system may provide to the user feedback such as “I estimate that you are thirsty, and I suggest that you prefer juice over beer.”

Some embodiments may use a “predictive auto-launcher of applications” module 487, for automatic launch of an application on an electronic device, based on predictive estimations that are based on brainwave activity. The system records user's brain pattern as well as the actual actions of opening an application on his smartphone. Using the correlation between these actions, the system learns when the user is thinking (via brain activity) about opening application X, and may suggest to open it for him, or may directly open it immediately, with or without a validation question.

The system continuously records user's brain activity. It also knows when the user opened application X on his smartphone. By keeping track of both information channels (the brain activity and user's physical actions on the screen to open applications), the system stores the specific brain activity of the user's at the moment that he opened application X. Later, the system may recognize brain activity that is similar to the brain activity that user had when he opened application X, and thus the system may ask the user “would you like to open application X?” or may directly open this application without a validation question. The system may learn the user's patterns of action (in this case: when he opens which application), and may and correlate it to user's brain activity; and this way the system may predictively suggest an action.

In another example, the system may identify that when the user thinks “I am bored”, he later typically launches the game “Angry Birds”; and the system may learn this pattern such that, the next time that the system identifies an “I am bored” thought by this user, the system may automatically launch that game, with or without user confirmation to do so.

Some embodiments may utilize a “Think to Cast a Vote” module 488, allowing the system to learn how the user think of each candidate in the list (while the list is presented to the user) and then, identifying which candidate the user is thinking of and inform of his choice. For example, while watching a television program where the audience at home are requested to vote by calling or texting (e.g., call number X to vote for Adam, call number Y to vote for Eve”); the system may operate in the following manner: While the names of the candidates are shown (Visually and/or verbally) on the television screen (or are conveyed otherwise, via radio, via text, or the like), the system records the user's brain signals and stores them with a tag of which candidate was presented at this time period. After the complete list of candidates was presented, and all data registered and tagged by our system, the user now has to think of his favorite candidate. The system compares (performs correlation) between the present brain waves and all previous recorded signals. It then recognizes which signal best match the present brain signal and use the tag (e.g., candidate name) from this signal as the user's favorite candidate. Then, the system may perform the voting by a suitable means (phone call, text message); for example, call the TV program telephone line and beep the tone that corresponds to the number of the candidate, or say the candidate's name to the phone, or other suitable mechanism.

In another implementation, the system may allow to vote by thought, while also allowing the user to “split” the vote between two or more candidates. Following the same example, if at the final stage of voting, the system recognizes that the user's brain pattern correlates 20% to “Adam” and 80% to “Eve”, the system may make a multi-choice vote and allocate 20% of the user's vote to candidate Adam, and 80% to candidate Eve.

Some embodiments may include a brainwave-based text auto-complete module 489; for example, the system tracks sensors inputs and user typing of email, documents, text messages; and builds probabilities to common words and phrases that the user may often use in SMS text messages, as well as correlations between specific letters or words or uncompleted words, and brainwave signals that are obtained from the user during such composing time. This may allow the system, for example, to auto-complete words or sentences, based on correlations between the so-far composed text, with EEG or brainwave signals or other signals captured from the user, which may help the system to estimate what the user intends to type next; not merely by using the most probable word to complete based on the characters he started typing, but rather, based on signals picked in the past in similar composing situation from this specific user, and their correlation to the brainwave signals that are being captured now. When the user starts typing a message, the system may auto-complete the word/phrase user started (with or without validation procedure), based on the user's thought(s) and optionally taking into account past records or history of word usage of that user.

For example, every time that the user composes a text or email or document or SMS, the system may store the user's brain activity second by second, and also correlate this with the characters or words that the user types in each second (or another, smaller, time-frame that may be preset). This process of recording user's brain signals with tags of the letters typed is constantly and automatically done by the system. If at some point, the system recognizes brain pattern that matches any of the one-character typed (or sequence of few characters typed) previously by the user), the system may now estimate or predict what is the most probable remainder of the text that the user is probably going to type. The system may auto-complete a word or phrase or complete sentence, before the user completed it himself, based on current brainwave activity compared to previous reference brainwave activity. It may suggest auto-complete options, and allow the user to accept the suggestion or ignore it and keep typing.

Similarly, the system may complete text message writing by thought; the system generates a complete SMS or Twitter message based on user's state of mind/thoughts/mood. Each time that the user writes an SMS or Twitter message, the system may have a complete record of the brain activity thought, as well as a complete knowledge of all the characters typed in this message. After several times that the system registers this data, it may start predicting a message before the user ended typing it, based on user thought analysis. More specifically, in case of an SMS or Twitter message that was already typed before, the system may predict, and therefore suggest to auto-complete or entirely write (and also send) the complete text, based on user's typing and/or brain activity so far, and before the user typed it all. The result is that in case of writing SMS with the same text that was written before, the system may identify, predict and auto-complete this text for the user. For example: If user types SMS: “Are you free for lunch today?” or “Are you at home?”, the next time such a SMS is written by the user, the system may predict it and auto-complete it based on its beginning character and by taking into account current brainwave activity which may be similar to previously-recorded brainwave activity.

It is noted that the auto-complete of text being composed, based on the intended text that the user is intending to compose, may be user-specific, and may be tailored based on the particular brainwave activity of the user, may not necessarily be identical or similar to an auto-complete feature that is based on probability or statistics of most-common words (or phrases) used in messages in general. For example, a conventional system may auto-complete the characters to “kn” to become “know” or “knowledge” or “knife” or “knives”, based on statistical probability of most-common words used in the English language, or based on the user-specific statistical probability based on history of text messages; whereas, the present invention may choose among the possible auto-complete options, based on the currently-captured brainwave activity signals, and based on their comparison to previously-captured brainwave activity signals that were captured in previous composing events by that specific user, for example, indicating that the user is currently thinking positively about a “knife” and not about “know” or “knowledge” or “knives”.

Some embodiments may utilize a brainwave-based entertainment suggesting module 490; the system learns the connection (pattern correlations) between the user's brain waves and the user's choice of television shows or radio stations or media channels; after sufficient automatic training, the system may be able to tell the user, when the user asks for it, to recommend which channel the user should see or listen to, based on the user's brainwaves.

For example, the system may record user's brain activity patterns and the TV/Radio or other channels he is currently watching or listening to. As time goes, the system may automatically accumulate data about the correlation to the user's choice of channels. When the user asks the system to suggest channel to watch, the system may calculate how close are the user's current brain signals to other brain signals of that same user from the past, and may provide a recommendation to watch (or listen to) a channel most correlated to the user's current brain activity. If, for example, user watched a Music TV channel when he was very tired, the system may automatically learn this correlation between brain signals indicating fatigue and watching a Music TV channel. This way, when the user is tired and asks the system to choose a channel for him, the system may be able to recognize that it is best to suggest the Music TV channel; and optionally, the system may command the television to automatically turn-on and/or to switch to that channel.

In another implementation, the system may also record and correlate the information with the day of the week, and/or the time-of-day, so that the recommendation of television channel to watch may take into consideration also the specific programs on television that are broadcasted now; and the system may be able to tell which of tonight's programs is best to recommend the user to watch, based on past brainwave activity and current brainwave activity. For example: if today is Tuesday at 8 PM, and the user usually watches either the news on channel 5, or “Who wants to be a Millionaire” on channel 11, or “National Geographic—Airplane Investigations” on channel 21; then, when the user asks the system to suggest the best channel to watch now, the system may look for the best correlation of user's current brain activity with correlation to these three options (e.g., before making a correlation with Any channel that the user ever watched). If the system identifies high correlation to one out of these three programs, then it may suggest one of these programs accordingly.

Some embodiments may utilize a brainwave-based social-media action performer module 491, which may automatically perform or commit a “like” or “follow” operation on a social network, with regard to content that the user is consuming; either in the virtual space or (by utilizing input devices like Google Glass) in the real world. For example, many platforms may allow users to express their opinion toward virtual subjects by the “Like” or “Fan” or “Follow” action. For example, in Facebook a user may “Like” any object that is connected to the social graph. Using the invention, users may not have to explicitly do anything to commit a Like action. Since the invention has an ability to detect brainwaves and monitor face muscles, it may detect when the user “likes” or “dislikes” something. The invention may combine data from different input methods and sensors (such as microphones, video camera sensors, access to the screen the user is watching) and/or brainwaves to conclude what is the object that the user is thinking of. Given this information, the invention may either store for later use (e.g., when the user is looking for something to do, it would remind him that he read the plot of a movie and liked it, and therefore suggest him to go see that movie), or may share with his friends via social channels.

Moreover, the invention may be used as an alternative for measuring popularity online. For example, the invention may rate a movie on YouTube, based on the users' feelings or thoughts while watching it. That way the rating may be more comprehensive than just number of views and like/dislike, but rather measurements like “made 5 people laugh”, or “made 4 people cry”, or “made 8 people sad”, or the like.

The invention may be used in combination with input methods such as wearable cameras (devices such as Google Glass) or Augmented Reality (AR) glasses or helmets or headsets; and may log and share user's feelings toward real life objects and events (e.g., the user loved the movie X, the user liked the cake in bakery Y, or the like).

Some embodiments may provide a learning helper module 492, for example, a mechanism that may use bio-feedback and other information (such as understanding or confusion) to adapt educational material to a particular student or user. The invention may be used as part of a personal learning machine. Given the invention's abilities to: monitor concentration level of the user, and monitor understandings or confusion, as well as, for example, monitoring tiredness and/or monitoring emotions; and given access to the material the user is learning (e.g., text that is read from the screen, or a YouTube movie being watched), the system may provide a user-tailored personal learning experience.

The invention may be adaptive to the user or student. For example, if the system detects that the student is confused or does not completely understand the material, it may show more examples and more explanations. If it detects that he is bored, and following up with the material, it may speed up the pace of learning. If it detects that the student is tired, it may schedule a break with a specific length in view of the student's fatigue level. Content providers may use an authoring tool that lets them specify how the system may handle different situations (such as, what to present to the student if he has difficulties with a specific topic, or if he is tired or bored). The system may automatically fetch more content based on the level of understanding of the user (e.g., the system may detect the user had difficulty when the he read about a particular topic in the essay that he was reading, and may search the Internet for more explanations on that topic).

Some embodiments may utilize a module 493 for passive training via context understanding; such that the system may passively learn from the user's actions or things he says. The invention may use algorithms to extract meaningful information from brainwaves and other bio-sensors. Some of those algorithms may need training in advance, and some of them may be based on supervised learning (such that feedback throughout the usage of the system may improve the performances of the algorithm). The system may collect such feedback without actively interacting with the user, but by analyzing the user actions and by understanding the context of usage.

For example, the system concludes that the user wants to launch an application; but one second after the application was launched it was also closed by the user; from past experience, the system logs show that the user usually uses this application for an average of ten minutes; therefore the system may conclude that there was a mistake in deducing that the user wanted to launch the application. This does not necessarily mean that the system was wrong; perhaps the user was confused, but this even may still provide some feedback, that may be used in combination with other feedback to improve the algorithms performance.

Another means for passive training is by listening to the user. The system may hear what the user says, and it may try and learn from this data what the user thinks; and then it may use such deduced thought as input for the training algorithm. For example, the system might hear the user says “John”, and it may analyze the brainwaves from the time frame just before the user said “John”. Given several different samples where the user said (and thought) “John”, the invention may detect the relevant pattern that may translate to “John”. This means that the system may learn and train passively, without asking from the user to perform any special action.

Similarly, the system may utilize training via a voice interface. The system may require the user to train it, in order to be able to extract meaningful information from the sensor readings. In this training phase the user may describe what is he thinking about, and he may be thinking the same thought over and over until the system detects a sufficiently reliable brainwave pattern that it is able to link to this particular thought. Another possible approach is to ask the user to think about a specific object or action (instead of asking the user to describe what he is thinking about).

The system may use voice user interface to accomplish this task. The system may use some means of audiological output (such as earphones, speaker), optionally in combination with other means of user interface (such as computer monitor) to instruct the user what is expected from him (e.g., to repeat the last thought, or to think about nothing in particular). The system may use means of audiological input in order to get input from the user (e.g., microphone); and it may combine this audio input with other means of input (such as a keyboard).

Some embodiments may include a brainwave-based human efficiency estimator 494 that analyses user's actions and brainwaves to evaluate a user's efficiency and/or effectiveness at performing tasks, as well as help plan an effective schedule for work. The system monitors brainwave and personal bio-data from a user, as well as the actions the user performs with devices in his surroundings (computer, smartphone, tablet, or the like). The system identifies repeating patterns and correlations between the data, and uses this to predict the efficiency of the user's actions, thereby estimating/evaluating user's efficiency at different tasks (at work, at home, in school, or the like). The system may also use these insights to suggest to the user which actions may be most effective to do next, when to stop an action if it is not effective anymore, and/or how to plan his schedule of actions to be most efficient and productive.

For example, the system monitors user's brain wave (using EEG inputs or similar devices for brainwaves recording), and monitors and collects data from personal computer, smartphone or other devices (by following user's keystrokes, actions and commands used on these devices by the user). The data may be collected continuously and automatically in real time, whenever the user uses the system; and readings may be stored. By collecting the information over time, the system may identify patterns in the inputs, as well as correlations between actions done by the user and the signals received from his brain. Using these patterns and correlations, the system may predict (in real time) success rate of a task that the user is currently doing, the duration it would take the user to complete different actions and tasks, the emotions of the user while performing these actions and tasks, or the like.

For example, the system may monitor user's brainwaves while he types a document on the computer. It may correlate the brainwave patterns of the user with the effectiveness of the writing (e.g., how much text was typed in this period of time, how many times the user stopped working on the document and surfed the Internet or changed the music track he is listening to; how many times the user deleted text in this period). By correlating the effectiveness of performing the task at any given moment with the respective brainwaves of the user, the system may monitor and/or identify and/or correlate different brainwaves over time, and may assess user ability to concentrate or focus on a task. Combining this data with data collected from computer, smartphone and other such devices in real time, and from previous uses, may allow the system to predict to which extent the user is concentrated, whether the task the user is doing right now is the best fit with respect to his condition, other tasks and its requirements.

The system may also recognize which documents are related to which task, and may be able to analyze the effectiveness of the user at different tasks. For example, documents opened and edited in the “Science Magazine” folder may be recognized as work on “Science Magazine Project”; while opening and working with documents from the “Home Bills” folder may be tagged as a different kind of task. The system may then be able to analyze that the user is at his maximum concentration while working on the Science Magazine tasks, and usually less concentrated while working with the “Home Bills” files (or the other way around).

The system may analyze as meta-data (e.g., how long is the user working without a break; how fast is the user typing over a period of time) and meaningful events in the context of the user's work (e.g., successful or error-free code compilation in case of software development; deals signed in case of telemarketing or sell representative). The data representing how well the user is doing in a specific task, combined with the user's brain readings, and data from past experience, may allow the system to predict the amount of success and time that the current task or other optional task may take.

The system may create a working environment that is more efficient, enabled by allowing or blocking functionality based on the user's state (state of mind, emotions, concentration). For example, the system may block access to specific applications or websites (e.g., Facebook or social network(s), YouTube or entertainment sites, gaming sites or applications) when the user is concentrated; or may recommend to the user to take a break and allow (temporary, timed) access to such websites or applications if the user is beyond the peak of concentration.

The system may suppress different types of distractions, such as alerts and notification to the user by various devices around him, text messages, emails, phones calls, etc. For example, while the user is effective at writing text in a word processing software, the system may temporarily block (or delay) incoming SMS messages arriving on the smartphone, unless they are from the user's spouse or parent or other pre-defined sender(s); and the system may release such incoming messages when the user ends the period of time in which he is most concentrated at his task, as monitored by monitoring his brainwave activity.

In addition, the system may guide the user in planning his weekly tasks, for example: based on the data and correlations accumulated by the system from past use, it may recommend the user to schedule late at night the work on the new article for Science magazine, and to keep the work on the “Home Bills” for the afternoon, when he is usually more sleepy. Similarly, the system may suggest to the user to schedule work phone calls to New York office while the user drive to the office in the morning, and calls to the office in New Zealand done at the end of the day at the office, or on the way back home from the office; again, based on analysis of brainwave activity indicating increased or reduced effectiveness or efficiency.

Some embodiments may include a “Think to Purchase” module 495 (or Think to Own module, or Think to Acquire module), which may identify (based on brainwave activity analysis and/or comparison) that the user is thinking of a particular item (e.g., a book, a toy, a music file, a stock or a share of a corporation, or the like), or that the user is thinking of purchasing that particular item. Based on such brainwave-based identification, the system may proceed to automatically place a purchase order for said item, on behalf of said user, via an online merchant or vendor or retailer (e.g., via Amazon.com; or via a brokerage firm or a banking institution if the item is a share or a security), on which the user has a user account. Optionally, the item may be delivered to the default (or the pre-defined or preferred) shipping address on file for the user at said merchant; and the payment may be automatically performed by the default (or pre-defined, or preferred) billing method or payment method that the user has with such merchant or vendor. Optionally, the feature of “think to purchase” may be activated or deactivated by the user, in an “account settings” section of such online merchant or vendor. The present invention may thus allow a unique capability, in which a user may merely Think of an item, and by completing such thought within his brain, without having to press any key or move a mouse or click a mouse or tap a screen, that item may be purchased on his behalf and shipped to him, and the title and ownership in such item may immediately transfer to the benefit of the user immediately upon such Thought.

Some embodiments may include a “Think to Ask” module 496 (which may also be referred to as “Think to Search” or “Think to Inquire” or “Think to Research” or “Think to Google”), which may identify (based on brainwave activity analysis and/or comparison) that the user is thinking of a particular question (e.g., a general knowledge question, such as “which mountain is the tallest in the whole world”; or a particular question, such as, “what are the opening hours of Rich Bank in my town today?”). In response to such brainwave-based identification, and by using one or more keywords from said identified questions or by using other contextual analysis of said question, the system may automatically obtain an answer (or one or more possible answers) to said question, from the Internet or from a particular online source (e.g., Wikipedia.com), and may immediately present such answer(s) to the user, for example, as text and/or graphics and/or audio/video through the smartphone of the user, or by whispering the answer (using a text-to-speech converter) via an earphone into the user's ear, or by displaying the answer on a Google Glass device or on a HIVID or OHMD that the user is wearing, or the like.

Some embodiments may use a “thought-based friend-availability inquiry module” 497, to query by brainwaves if a friend is available to talk with. The system may identify user's request to talk with friend X; it may then communicate with X's system and based on the brain waves of X, the system of X may reply to the user's system when it is a suitable time to contact X. Based on this info, user's system may contact X at the suitable time. In this example, X is another user who is also equipped with a similar or other electronic device.

Any one or more of the modules described above, may be implemented in software and/or in hardware; and may be comprised in smartphone 101 (or in another electronic device), and/or may be comprised in computer 103, and/or may be comprised in headset 102; and/or may be distributed, functionally and/or structurally, across multiple units (e.g., across one or more of: smartphone 101, headset 102, and/or computer 103).

One or more of the features or functions that are described above in connection with a particular implementation, may be used in conjunction with one or more other implementations.

The invention may be implemented using suitable hardware components and/or software modules, which may include, for example, a processor, a Central Processing Unit (CPU), a Digital Signal Processor (DSP), a controller, an Integrated Circuit (IC), a memory unit, a storage unit, accumulators, buffers, a power source, wired communication links, wireless communication links, antennas, transceivers, transmitters, receivers, input units (e.g., keyboard, mouse, touchpad, touch-screen, microphone), output units (e.g., audio speakers, display, screen), or the like. One or more of the devices described herein may include an Operating System, drivers, software applications, or the like.

Discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

Some embodiments of the present invention may be implemented by using a suitable combination of hardware components and/or software modules, which may include, for example: a processor, a central processing unit (CPU), a digital signal processor (DSP), a single-core or multiple-core processor, a processing core, an Integrated Circuit (IC), a logic unit, a controller, buffers, accumulators, registers, memory units, storage units, input units (e.g., keyboard, keypad, touch-screen, stylus, physical buttons, microphone, on-screen interface), output units (e.g., screen, touch-screen, display unit, speakers, earphones), wired and/or wireless transceivers, wired and/or wireless communication links or networks (e.g., in accordance with IEEE 802.11 and/or IEEE 802.16 and/or other communication standards or protocols), network elements (e.g., network interface card (NIC), network adapter, modem, router, hub, switch), power source, Operating System (OS), drivers, applications, and/or other suitable components.

Some embodiments of the present invention may be implemented as an article or storage article (e.g., CD or DVD or “cloud”-based remote storage), which may store code or instructions or programs that, when executed by a computer or computing device or other machine, cause such machine to perform a method in accordance with the present invention.

Some embodiments of the present invention may be implemented by using a software application or “app” or a “widget” which may be downloaded or purchased or obtained from a website or from an application store (or “app store” or an online marketplace).

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents

What is claimed is:

1. A method comprising:
capturing through one or more electrodes, located in proximity to a brain of a user, signals of brainwave activity of said user;
analyzing said signals to detect a pattern of brainwave activity of said user;
based on the detected pattern, determining that the user thinks about a command that controls an electronic device;
based on said determining, triggering the electronic device to perform said command.

2. The method of claim 1, wherein the analyzing comprises:
comparing a current pattern of brainwave activity of said user, to one or more patterns previously-recorded in a training session.

3. The method of claim 1, wherein the analyzing comprises:
based on user behavior subsequent to performance of said command, generating positive feedback indicating that the determination that the user was thinking about said command was correct.

4. The method of claim 1, wherein the analyzing comprises:
based on user behavior subsequent to performance of said command, generating negative feedback indicating that the determination that the user was thinking about said command was incorrect.

5. The method of claim 1, wherein the analyzing comprises:
locally analyzing said signals at a wearable a headset comprising said one or more electrodes and further comprising a processor able to locally perform said analyzing.

6. The method of claim 1, wherein the analyzing comprises:
wirelessly transmitting said signals to a processor detached from said electrodes;
analyzing said signals at said processor.

7. The method of claim 1, wherein the analyzing comprises:
wirelessly transmitting said signals to said electronic device which is detached from said electrodes;
analyzing said signals at said electronic device by a processor comprised in said electronic device.

8. The method of claim 1, wherein the electronic device comprises a device selected from the group consisting of:
a smartphone, a tablet, an audio player, a video player, a personal computer, a laptop computer, a gaming device, an electronic book reader.

9. The method of claim 1, wherein analyzing said signals comprises:
down-sampling said signals from a first sampling rate at which said signals are captured, to a second, reduced, sampling rate;
analyzing the down-sampled signals.

10. The method of claim 1, wherein analyzing said signals comprises:
determining a context of said electronic device;
taking into account said context within said analyzing of said signals.

11. The method of claim 1, wherein analyzing said signals comprises:
determining a context of said electronic device;
determining that said pattern of brainwave activity corresponds to two or more possible interpretations corresponding to two or more commands, respectively;
selecting to execute one of said two or more commands by taking into account said context of the electronic device.

12. The method of claim 1, comprising:
in a think-to-unlock module, determining that said pattern of brainwave activity corresponds to a user thought of a command to unlock an electronic device; and
triggering said electronic device to unlock.

13. The method of claim 1, comprising:
in a brainwave-based biometric module, extracting a pattern of brainwave activity of said user for subsequent utilization as a biometric property of said user.

14. The method of claim 1, comprising:
extracting a pattern of brainwave activity of said user for subsequent utilization as a user-specific treat for user authentication.

15. The method of claim 1, comprising:
in a brainwave-based challenge/response module,
presenting to the user a challenge,
capturing brainwave activity of said user in response to said challenge,
authenticating said user to a service, based on a match between (a) said brainwave activity in response to said challenge, and (b) previously-captured brainwave activity of said user.

16. The method of claim 1, comprising:
determining whether an estimated thought of a user, which is estimated based on said pattern of brainwave activity, is a user-triggered thought or an event-triggered thought;
determining that said pattern of brainwave activity corresponds to two or more possible interpretations corresponding to two or more commands, respectively;
selecting to execute one of said two or more commands by taking into account said determination of whether the estimated thought of the user is a user-triggered thought or an event-triggered thought.

17. The method of claim 1, comprising:
capturing multimedia data associated with activities of said user, the multimedia data comprises at least one of: video data, audio data;
based on analysis of said signals indicating brainwave activity, determining that a portion of said multimedia data corresponds to a time-period in which said user had a particular state-of-mind;
tagging said portion of the multimedia data with a tag indicating said particular state-of-mind.

18. The method of claim 17, wherein said state-of-mind comprises one or more of: happiness, sadness, excitement, boredom, being interested, being attentive, being distracted.

19. The method of claim 17, comprising:
receiving a user-provided state-of-mind tag;
automatically compiling a summary clip that comprises one or more portions of said multimedia data that correspond to said user-provided state-of-mind tag.

20. The method of claim 17, comprising:
overriding said tagging based on an utterance of the user indicating that said portion of the multimedia data is not to be tagged with said state-of-mind tag.

21. The method of claim 17, comprising:
overriding said tagging based on a thought of said user, estimated from sensed brainwave activity of said user, indicating that said portion of the multimedia data is not to be tagged with said state-of-mind tag.

22. The method of claim 1, comprising:
capturing multimedia data associated with activities of said user, the multimedia data comprises at least one of: video data, audio data;
based on analysis of said signals indicating brainwave activity of said user, identifying portions of said multimedia data which correspond to time-periods in which said user was happy;
automatically compiling a happiness-oriented summary clip that comprises said portions of said multimedia data.

23. The method of claim 1, comprising:
capturing multimedia data associated with activities of said user, the multimedia data comprises at least one of: video data, audio data;
based on analysis of said signals indicating brainwave activity of said user, identifying portions of said multimedia data which correspond to time-periods in which said user was excited;
automatically compiling an excitement-oriented summary clip that comprises said portions of said multimedia data.

24. The method of claim 1, comprising:
capturing multimedia data associated with a lecture that the user attends, the multimedia data comprises at least one of: video data, audio data;
based on analysis of said signals indicating brainwave activity of said user, identifying portions of said multimedia data which correspond to time-periods in which said user was focused;
automatically compiling a focus-oriented summary clip that comprises said portions of said multimedia data.

25. The method of claim 1, comprising:
capturing multimedia data associated with a text that the user reads, the multimedia data comprises at least one of: video data, audio data;
based on analysis of said signals indicating brainwave activity of said user, identifying portions of said multimedia data which correspond to time-periods in which said user was focused;
automatically compiling a focus-oriented summary clip that comprises said portions of said multimedia data.

26. The method of claim 1, comprising:
capturing multimedia data associated with a lecture that the user attends, the multimedia data comprises at least one of: video data, audio data;
based on analysis of said signals indicating brainwave activity of said user, identifying portions of said multimedia data which correspond to time-periods in which said user was unfocused;
automatically compiling a review-oriented summary clip that comprises said portions of said multimedia data.

27. The method of claim 1, comprising:
capturing multimedia data associated with a text that the user reads, the multimedia data comprises at least one of: video data, audio data;
based on analysis of said signals indicating brainwave activity of said user, identifying portions of said multimedia data which correspond to time-periods in which said user was unfocused;
automatically compiling a review-oriented summary clip that comprises said portions of said multimedia data.

28. The method of claim 1, comprising:
capturing multimedia data associated with a lecture that the user attends, the multimedia data comprises at least one of: video data, audio data;
based on analysis of said signals indicating brainwave activity of said user, identifying portions of said multimedia data which correspond to time-periods in which said user was interested in the lecture;
automatically compiling a user-specific interest-oriented summary clip that comprises said portions of said multimedia data.

29. The method of claim 1, comprising:
capturing multimedia data associated with a text that the user reads, the multimedia data comprises at least one of: video data, audio data;
based on analysis of said signals indicating brainwave activity of said user, identifying portions of said multimedia data which correspond to time-periods in which said user was interested in the text being read;
automatically compiling a user-specific interest-oriented summary clip that comprises said portions of said multimedia data.

30. The method of claim 1, comprising:
(a) providing to the user a first batch of one or more words in a first language in which the user is proficient;
(b) identifying a first brainwave activity of said user in response to said first batch;
(c) providing to the user a second batch of one or more words in a second language in which the user is non-proficient;
(d) identifying a second brainwave activity of said user in response to said second batch.

31. The method of claim 30, comprising:
based on a comparison of the second brainwave activity to the first brainwave activity, determining whether or not the user comprehends the second batch of one or more words in said second language.

32. The method of claim 30, comprising:
based on a comparison of the second brainwave activity to the first brainwave activity, determining to repeat at least one more iteration of steps (a), (b), (c) and (d).

33. The method of claim 1, comprising:
capturing audio uttered to said user;
based on analysis of said signals indicating brainwave activity of said user, identifying a particular batch of one or more words in said audio which the user does not understand;
automatically providing to said user a translation of said particular batch, from a source language to a user-preferred language.

34. The method of claim 33, wherein providing the translation comprises at least one of:
(a) providing to the user an audio utterance of the translation in the user-preferred language;
(b) displaying said translation on an optical head mounted display of said user.

35. The method of claim 1, comprising:
capturing audio uttered to said user;
based on analysis of said signals indicating brainwave activity of said user, identifying a particular batch of one or more words in said audio which the user does not understand;
automatically providing to said user an explanation of said particular batch;
wherein the explanation is provided to said user by at least one of: (a) an audio utterance of the explanation in the user-preferred language; (b) displaying said explanation on an optical head mounted display of said user.

36. The method of claim 1, comprising:
capturing a brainwave activity preceding immediately before said user performs a particular action;
allowing the user to complete said particular action without intervention;
and subsequently,
identifying subsequent brainwave activity of said user, and determining that the user is thinking about performing again said particular action.

37. The method of claim 36, comprising:
providing to said user a message notifying the user that he is thinking about performing again said particular action and advising the user to avoid performing said particular action.

38. The method of claim 36, comprising:
providing to said user a message notifying the user that he is thinking about performing again said particular action, and providing to said user information that assists the user in performing again said particular action.

39. The method of claim 1, comprising:
identifying an irregular brainwave activity of said user;
based on said identification, and based on a secondary indicator, initiating a medical alert regarding said user;
wherein the secondary indicator comprises at least one of: excessive sweating of said user; increased heartbeat rate of said user; irregular body temperature of said user.

40. The method of claim 1, comprising:
correlating between said brainwave activity, and at least one of: (a) a location at which the user is located, (b) a time-of-day, (c) an activity performed by said user;
taking into account said correlation within said analyzing of said signals.

41. The method of claim 1, wherein triggering the electronic device to perform said command comprises:
prior to said triggering, performing a validation process in which said user is requested to confirm that the command determined by said determining step is indeed a command that the user thought;
receiving user feedback comprising a user validation of said command;
only upon user validation, triggering the electronic device to perform said command.

42. The method of claim 41, wherein receiving the user feedback comprises:
capturing additional signals of brainwave activity which indicate that the user validates said command.

43. The method of claim 41, wherein receiving the user feedback comprises:
capturing additional signals of brainwave activity which indicate that the user re-thinks said command.

44. The method of claim 1, comprising:
determining that the user thinks that the user is in a distress situation; and
in response to such determination, wirelessly transmitting a distress signal to one or more pre-defined remote recipients.

45. The method of claim 1, comprising:
based on the brainwave activity of the user, determining that the user is thinking about a particular person;
determining that the particular person appears in a contact list stored on said electronic device;
initiating, through said electronic device of said user, a new communication session between said user and said particular person.

46. The method of claim 1, comprising:
based on the brainwave activity of the user, determining that the user is thinking about a particular code-word which represents a command to terminate an ongoing phone call;
in response, terminating a currently-ongoing phone call on said electronic device.

47. The method of claim 1, comprising:
based on the brainwave activity of the user, determining that the user is thinking about a particular pre-defined passphrase, that was previously associated with a batch of one or more operations that said electronic device is capable of performing;
in response, triggering said electronic device to perform said batch of one or more operations.

48. The method of claim 1, comprising:
when a telephone call is incoming to the electronic device, analyzing the brainwave activity of the user to determine if the user is thinking to accept the incoming telephone call or to reject the incoming telephone call;
based on said analyzing, performing acceptance or rejection of the incoming telephone call in accordance with the determined user thought.

49. The method of claim 1, comprising:
based on the brainwave activity of the user, determining that the user is thinking a command to increase a volume level of audio produced by said electronic device;
in response, triggering said electronic device to increase the volume level of said audio produced by said electronic device.

50. The method of claim 1, comprising:
based on the brainwave activity of the user, determining that the user is thinking a command to decrease a volume level of audio produced by said electronic device;
in response, triggering said electronic device to increase the volume level of said audio produced by said electronic device.

51. The method of claim 1, comprising:
based on the brainwave activity of the user, determining that the user is thinking a command to modify a brightness level of a screen of said electronic device;
in response, triggering said electronic device to modify the brightness level of the screen of said electronic device.

52. The method of claim 1, comprising:
based on the brainwave activity of the user, determining that the user is thinking a command to toggle an airplane mode of said electronic device, wherein the airplane mode comprises a mode in which all wireless transceivers of said electronic device are disabled;
in response, triggering said electronic device to toggle said airplane mode.

53. The method of claim 1, comprising:
based on the brainwave activity of the user, determining that the user is thinking a command to toggle a value of a binary operational parameter of said electronic device;
in response, triggering said electronic device to toggle the value of said binary operational parameter of the electronic device.

54. The method of claim 1, comprising:
based on the brainwave activity of the user, determining that the user is thinking of a command to scroll a list of selectable items displayed on said electronic device;
in response, triggering said electronic device to scroll said list.

55. The method of claim 54, comprising:
based on the brainwave activity of the user, determining that the user is thinking of a command to select an item from said list of selectable items displayed on said electronic device;
in response, triggering said electronic device to select said item from said list.

56. The method of claim 1, comprising:
turning-on a dictation-by-thought mode of said electronic device;
based on the brainwave activity of the user, determining that the user is thinking of a particular phrase of text comprising one or more words of a natural language;
adding said phrase to a text being composed on said electronic device.

57. The method of claim 1, comprising:
based on the brainwave activity of the user, determining that the user is thinking a command to toggle activation/deactivation of a camera of said electronic device;
in response, triggering said electronic device to toggle activation/deactivation of said camera of the electronic device.

58. The method of claim 1, comprising:
based on the brainwave activity of the user, determining that the user is thinking a command to advance an email program from a presently-displayed email message to a next email message;
in response, triggering said electronic device to advance the email program from the presently-displayed email message to the next email message.

59. The method of claim 1, comprising:
based on the brainwave activity of the user, determining that the user is thinking a command to launch a particular application that is installed on the electronic device;
in response, triggering said electronic device to launch said particular application that is installed on the electronic device.

60. The method of claim 1, comprising:
based on the brainwave activity of the user, determining that the user is thinking a command to close a currently-displayed application which is currently displayed on a screen of the electronic device;
in response, triggering said electronic device to close said currently-displayed application.

61. The method of claim 1, comprising:
based on the brainwave activity of the user, determining that the user is thinking a command to activate a command in a currently-running application which is currently displayed on a screen of the electronic device;
in response, triggering said electronic device to activate said command in said currently-running application which is currently displayed on the screen of the electronic device.

62. The method of claim 1, comprising:
based on the brainwave activity of the user, determining that the user is thinking a command to edit a meeting in a calendar application installed on the electronic device;
in response, triggering said electronic device to edit the meeting in the calendar application installed on the electronic device.

63. The method of claim 1, comprising:
based on the brainwave activity of the user, determining that the user is thinking a command to edit an alarm clock event in a clock application installed on the electronic device;
in response, triggering said electronic device to edit the alarm clock event in the clock application installed on the electronic device.

64. The method of claim 1, comprising:
based on the brainwave activity of the user, determining that the user is thinking a request to locate the electronic device;
in response, triggering said electronic device to convey its location to said user by generating an audible signal.

65. The method of claim 1, comprising:
based on the brainwave activity of the user, determining that the user is thinking a request to locate the electronic device;
in response, triggering said electronic device to convey its location to said user by wirelessly sending, to one or more pre-defined recipients, a message indicating a GPS location of said electronic device.

66. The method of claim 1, comprising:
performing a training session in which the user thinks of an image that corresponds to a password for a particular service;
recording brainwave activity of the user during said training session;
subsequently, based on brainwave activity analysis, authorizing an access to said particular service only if brainwave activity analysis indicates that the user thinks of said image.

67. The method of claim 1, comprising:
based on the brainwave activity of the user, determining that the user is thinking of a command to perform a touch-screen gesture on a touch-screen of the electronic device, wherein the touch-screen gesture comprises a gesture selected from the group consisting of: zoom-in, zoom-out, scroll down, scroll up, swipe right, swipe left, swipe down, swipe left;
in response, triggering said electronic device to operate as if said touch-screen gesture was performed on the touch-screen of the electronic device.

68. The method of claim 1, comprising:
based on analysis of brainwave activity of the user, determining that the user switched from being non-alert to being alert;
in response, triggering said electronic device to switch from locked mode to unlocked mode.

69. The method of claim 1, comprising:
based on analysis of brainwave activity of the user, determining that the user switched from being alert to being drowsy;
in response, triggering said electronic device to gradually fade-out audio being played on the electronic device.

70. The method of claim 1, comprising:
based on analysis of brainwave activity of the user, determining that the user switched from being alert to being drowsy;
in response, triggering said electronic device to pause an application currently running on the electronic device.

71. The method of claim 1, comprising:
performing a machine-training session in which the user repeatedly thinks of a particular command;
capturing brainwave signals during said training session;
storing the captured brainwave signals as reference signals for subsequent analysis of subsequent brainwave signals.

72. The method of claim 1, comprising:
based on analysis of brainwave activity of the user, determining a single thought of the user;
based on said single thought, triggering said electronic device to automatically perform a batch of two or more pre-defined operations.

73. The method of claim 1, comprising:
based on analysis of brainwave activity of the user, and while the user is composing a text message on said electronic device, determining that the user is feeling a particular emotion;
automatically adding, to said text message that the user is composing on said electronic device, an emoticon representing said particular emotion.

74. The method of claim 73, comprising:
based on analysis of brainwave activity of a recipient of said text message, determining that said recipient is feeling another emotion;
notifying to said recipient, that the emotion that said recipient is feeling differs from the emotion that said user was feeling when said user was composing said text message.

75. The method of claim 1, comprising:
based on analysis of brainwave activity of the user, and while the user is listening to a particular song of a playlist via a music player application of said electronic device, determining that the user is thinking a command to advance said music player application to a different song from said playlist;
based on said determining, triggering said music player application of said electronic device to play said other song of said playlist.

76. The method of claim 1, comprising:
based on analysis of brainwave activity of the user, determining that the user is thinking about a particular song;
based on said determining, automatically obtaining a digital format of said song from an online music store.

77. The method of claim 1, comprising:
based on analysis of brainwave activity of the user, determining that the user is thinking about purchasing a particular item;
based on said determining, automatically placing a purchase order for said particular item, on behalf of said user, at an online store.

78. The method of claim 1, comprising:
based on analysis of brainwave activity of the user, determining that the user is feeling a particular emotion;
based on said determining, automatically selecting to playback to said user, on said electronic device, music that corresponds to said particular emotion.

79. The method of claim 1, comprising:
based on analysis of brainwave activity of the user, determining one or more properties of a state-of-mind of said user;
based on said determining, generating advertisement content tailored to suit said particular state-of-mind of said user.

80. The method of claim 1, comprising:
based on analysis of brainwave activity of the user, determining one or more properties of a state-of-mind of said user;
based on said determining, serving to said user Internet content tailored to suit said particular state-of-mind of said user.

81. The method of claim 1, comprising:
based on the brainwave activity of the user, determining that the user is thinking a command to toggle activation/deactivation of an electronic appliance other than said electronic device;
in response, wirelessly triggering said electronic appliance to toggle activation/deactivation of said electronic appliance.

82. The method of claim 1, comprising:
based on the brainwave activity of the user, determining that the user is thinking a command to toggle activation/deactivation of a vehicular component other than said electronic device;
in response, wirelessly triggering said vehicular component to toggle activation/deactivation of said vehicular component.

83. The method of claim 1, comprising:
based on analysis of brainwave activity of the user, and while the user is watching a particular channel on a television, determining that the user is thinking a command to switch the television to a different channel;
based on said determining, automatically and wirelessly switching said television to said different channel.

84. The method of claim 1, comprising:
based on analysis of brainwave activity of the user, and while the user is listening to a particular channel on a radio, determining that the user is thinking a command to switch the radio to a different channel;
based on said determining, automatically and wirelessly switching said radio to said different channel.

85. The method of claim 1, comprising:
based on analysis of brainwave activity of the user, and while the user is seated in a non-moving vehicle, determining that the user is thinking a command to start an ignition of said vehicle;
based on said determining, automatically starting the ignition of said car.

86. The method of claim 85, wherein automatically starting the ignition of said car is performed (a) without turning a car key, and (b) without pressing a vehicular button.

87. The method of claim 1, comprising:
based on the brainwave activity of the user, determining that the user is thinking a command to control an electronic appliance other than said electronic device;
in response, wirelessly controlling said electronic appliance in accordance with said command that said user is thinking.

88. The method of claim 1, comprising:
based on the brainwave activity of the user, determining that the user is thinking a command to control an illumination level of a dimmer light;
in response, wirelessly triggering said dimmer light to modify said illumination level in accordance with said command that said user is thinking.

89. The method of claim 1, comprising:
based on the brainwave activity of the user, and while the user is reading an electronic book on said electronic device, determining that the user is thinking a command to turn a page of said electronic book;
in response, triggering said electronic device to turn the page in said electronic book that the user is reading.

90. The method of claim 1, comprising:
based on the brainwave activity of the user, and while the user is watching a television program that includes audience voting, determining that the user is thinking a command to cast a vote in favor of a particular option out of multiple options;
in response to said determining, automatically casting said vote, on behalf of said user, in favor of said particular option.

91. The method of claim 90, wherein automatically casting said vote comprises an operation selected from the group consisting of:
automatically casting said vote by automatically sending an SMS message;
automatically casting said vote by automatically placing a telephone call;
automatically casting said vote by automatically via an Internet-based voting interface.

92. The method of claim 1, comprising:
presenting to the user, via said electronic device, a yes-or-no question;
based on the brainwave activity of the user, determining whether the user is thinking “yes” or “no”;
in response to said determining, providing to at least one application of said electronic device a signal indicating whether the user is thinking “yes” or “no”.

93. The method of claim 1, comprising:
based on the brainwave activity of the user, determining that the user is thinking a particular question that includes one or more keywords;
in response to said determining, and based on said one or more keywords, automatically obtaining from the Internet an answer to said particular question; and presenting said answer to said user via said electronic device.

94. The method of claim 1, comprising:
based on the brainwave activity of the user, determining that the user is thinking a question which queries what is a current time;
in response to said determining, notifying the current time to said user.

95. The method of claim 1, comprising:
based on the brainwave activity of the user, determining that the user is thinking a question which queries what is a current calendar date;
in response to said determining, notifying the current calendar date to said user.

96. The method of claim 1, comprising:
based on the brainwave activity of the user, determining that the user is thinking about a particular person;
in response to said determining, automatically querying whether or not said particular person is available to communicate with said user.

97. The method of claim 1, comprising:
based on the brainwave activity of the user, determining that the user is thinking a question which queries who is a person that said user is communicating with;
in response to said determining, automatically obtaining identifying information about said person, and notifying said identifying information to said user.

98. The method of claim 1, comprising:
based on brainwave activity of a non-human animal, determining a state-of-mind of said non-human animal;
in response to said determining, notifying to said user the determined state-of-mind of said non-human animal.

99. The method of claim 98, wherein determining the state-of-mind of said non-human animal comprises at least one of:
based on brainwave activity of said non-human animal, determining that said non-human animal is happy;
based on brainwave activity of said non-human animal, determining that said non-human animal is sad;
based on brainwave activity of said non-human animal, determining that said non-human animal is angry;
based on brainwave activity of said non-human animal, determining that said non-human animal is anxious.

100. The method of claim 1, comprising:
based on analysis of brainwave activity of the user, and while the user is composing a text message on said electronic device, determining that the user is thinking a particular phrase that the user did not yet fully type;
based on said determining, automatically completing to type said particular phrase on said electronic device.

101. The method of claim 1, comprising:
based on analysis of brainwave activity of the user, and while the user is browsing an Internet web-page having a social media button, determining that the user likes said Internet web-page;
based on said determining, automatically engaging said social media button to signal that the user likes said Internet web-page.

102. The method of claim 1, comprising:
based on analysis of brainwave activity of the user, and while the user is browsing an Internet web-page having a social media button, determining that the user would like to follow said Internet web-page;
based on said determining, automatically engaging said social media button to signal that the user would like to follow said Internet web-page.

103. The method of claim 1, comprising:
based on analysis of brainwave activity of the user, and while the user is reviewing educational content, determining whether the user feels confusion or understanding of the educational content;
based on said determining, automatically signaling to a server of said educational content whether the user feels confusion or understanding of the educational content.

104. The method of claim 1, comprising:
based on analysis of brainwave activity of the user, determining that the user is thinking of being late to a pre-scheduled meeting;
extracting from a calendar application that is utilized by said user, contact details of at least one attendee of said pre-scheduled meeting;
wirelessly sending to said at least one attendee of said pre-scheduled meeting a notification from said user, indicating that said user will arrive late to said pre-scheduled meeting.
